(19) United States
(12) Patent Application Publication
(10) Pub. No.: US 2026/0093067 A1
(43) Pub. Date: Apr. 2, 2026

(54) MULTICORE OPTICAL FIBER WITH LARGE CLADDING DIAMETER AND HIGH MECHANICAL RELIABILITY

(71) Applicant: CORNING INCORPORATED, CORNING, NY (US)

(72) Inventors: Scott Robertson Bickham, Corning, NY (US); Garth Weber Scannell, Corning, NY (US)

(21) Appl. No.: 19/290,691

(22) Filed: Aug. 5, 2025

Related U.S. Application Data
(60) Provisional application No. 63/699,856, filed on Sep. 27, 2024.

(51) Int. Cl. G02B 6/02

(52) U.S. Cl. CPC G02B 6/02042; G02B 6/02009

(57) ABSTRACT

Embodiments of current disclosure include a multicore optical fiber including a radius R_{CC} ranging from 126 μm to 180 μm, and core elements disposed within the common cladding. The common cladding may include an inner common cladding region, and an outer common cladding region surrounding the inner common cladding region and doped with TiO₂. At least one core element may include a core region, a dedicated inner cladding region surrounding the core region, and a dedicated outer cladding region surrounding the dedicated inner cladding region. A mode field diameter at 1310 nm of the at least one core element may be greater than or equal to 8.6 μm. The at least one core element may be separated from a nearest-neighbor core element by a minimum separation distance D_{NN} greater than or equal to 35 μm and less than or equal to 43 μm.

This application claims the benefit of priority under 35 U.S.C. § 119 of U.S. Provisional Application Ser. No. 63/699,856 filed on Sep. 27, 2024, the content of which is relied upon and incorporated herein by reference in its entirety.

### FIELD

The present disclosure pertains to optical fibers. More particularly, the present disclosure relates to multicore optical fibers having an enlarged common cladding diameter and a titanium-doped portion in the common cladding.

### BACKGROUND

As bandwidth demands increase, Ethernet switches and optics both need to keep pace in terms of cost per capacity, bandwidth density, and energy efficiency. The capacities of merchant switch silicon ASICs (application-specific integrated circuits) and optical modules have both increased forty-fold between 2010 and now, from 0.64 to 25.6 Tb/s, and from 10 to 400 Gb/s, respectively. The footprint of optical switches has decreased by over 80% in the last 10 years while the aggregate bandwidth has increased by a factor of 40.

This increase in bandwidth density is motivating the development of spatial division multiplexing solutions, such as reduced clad fibers (RCFs) and multicore fibers (MCFs) that enable more fiber cores to be deployed in a given footprint. Multicore fiber development efforts have been focusing on 4-core solutions with a cladding diameter of 125 μm, such as 4-core designs which have either a linear 1×4 configuration or a symmetric 2×2 configuration. The linear configuration is well-suited for coupling to silicon-photonics chips which have linear arrays of lasers and photodiodes, while the 2×2 configuration has been proposed for longer-length applications, such as data center interconnects (DCIs).

There is interest in a multicore fiber with more than four cores. However, efforts to incorporate more cores into a 125 μm cladding diameter have yielded unacceptable levels of crosstalk in the C-band (1530 nm to 1565 nm) and/or have required a reduction in the core size and concomitant mode field diameter (MFD). Fibers with more cores and cladding diameters greater than 125 μm have been explored, but the larger cladding diameter may decrease the long-term mechanical reliability. Accordingly, there is a need for improved multicore fibers.

### SUMMARY

Described herein include embodiments of multicore optical fibers having a common cladding diameter greater than or equal to 126 μm and less than or equal to 180 μm which may allow for increased nearest-neighbor spacing among core elements, thereby delivering low crosstalk and/or low coating leakage loss in the C-band. An outer portion of a common cladding of the multicore optical fiber may be doped with titanium, thereby achieving mechanical reliability equivalent to or better than 125 μm silica-clad multicore optical fibers.

In some embodiments, a multicore optical fiber may include a common cladding having a radius R_{CC} that may be greater than or equal to 126 μm and less than or equal to 180 μm, and a plurality of core elements disposed within the common cladding. The common cladding may include an inner common cladding region, and an outer common cladding region surrounding the inner common cladding region. The outer common cladding region may include a TiO₂-doped glass region. At least one core element of the plurality of core elements may include a core region, a dedicated inner cladding region surrounding the core region, and a dedicated outer cladding region surrounding the dedicated inner cladding region. A mode field diameter at 1310 nm of the at least one core element may be greater than or equal to 8.6 μm. The at least one core element may be separated from a nearest-neighbor core element by a minimum separation distance D_{NN} that may be greater than or equal to 35 μm and less than or equal to 43 μm.

### BRIEF DESCRIPTION OF THE DRAWINGS

The accompanying drawings are included to provide a further understanding and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying figures.

FIG. 1A schematically depicts a cross-sectional view of an exemplary multicore optical fiber.

FIG. 1B schematically depicts a cross-sectional view of a further exemplary multicore optical fiber.

FIG. 1C schematically depicts a cross-sectional view of another exemplary multicore optical fiber.

FIG. 1D schematically depicts a cross-sectional view of another exemplary multicore optical fiber.

FIG. 2 schematically depicts a cross-sectional view of an exemplary core element.

FIG. 3A plots an exemplary refractive index profile of a core element.

FIG. 3B plots another exemplary refractive index profile of a core element.

FIG. 4 is a plot of modeled values of allowable bend stress and allowable common cladding radius as a function of TiO₂ dopant concentration.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this Detailed Description.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

In this specification and in the claims which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

A multicore optical fiber, also referred to as a multicore optical fiber or “MCF”, is considered for the purposes of the present disclosure to include two or more core elements disposed within a common cladding. Each core element can be considered as having a core region surrounded by one or more dedicated cladding regions. A cladding region is said to be “dedicated” if it surrounds the core region of only one core element of the two or more core elements and is said to be “common” if it surrounds the core regions of at least two core elements of the two or more core elements.

The length dimension “micrometer” may be referred to herein as micron (or microns) or μm.

The “refractive index profile” is the relationship between refractive index or relative refractive index and radial distance r from the core element's centerline for each core element of the multicore optical fiber. For relative refractive index profiles depicted herein as relatively sharp boundaries between various regions, normal variations in processing conditions may result in step boundaries at the interface of adjacent regions that are not sharp. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (core region and/or any of the cladding regions), it may be expressed in terms of its actual or approximate functional dependence or in terms of an average value applicable to the region. Unless otherwise specified, if the relative refractive index of a region (core region and/or any of the dedicated and/or common cladding regions) is expressed as a single value, it is understood that the relative refractive index in the region is constant, or approximately constant, and corresponds to the single value or that the single value represents an average value of a non-constant relative refractive index dependence with radial position in the region. Whether by design or a consequence of normal manufacturing variability, the dependence of relative refractive index on radial position may be sloped, curved, or otherwise non-constant.

The “relative refractive index” or “relative refractive index percent” as used herein with respect to multicore optical fibers and core elements of multicore optical fibers is defined according to equation (1):

$$Δ \% = 100 \frac{{n}^{2} ( r ) - {n}_{c}^{2}}{2 {n}^{2} ( r )} \qquad ( 1 )$$

where n(r) is the refractive index at the radial distance r from the core element's centerline for the core region and dedicated cladding region(s) of each core element or the refractive index at the radial distance r from the central fiber axis of the multicore optical fiber for the common cladding region(s) at a wavelength of 1550 nm unless otherwise specified, and n_{c} is 1.444, which is the refractive index of undoped silica glass at a wavelength of 1550 nm. As used herein, the relative refractive index is represented by Δ (or “delta”) or Δ% (or “delta %) and its values are given in units of “%” or “% Δ”, unless otherwise specified. Relative refractive index may also be expressed as Δ(r) or Δ(r) %. When the refractive index of a region is less than the reference index n_{c}, the relative refractive index is negative and can be referred to as a trench. When the refractive index of a region is greater than the reference index n_{c}, the relative refractive index is positive, and the region can be said to be raised or to have a positive index.

The average relative refractive index of a region of the multicore optical fiber can be defined according to equation (2):

$$Δ \% = \frac{{\int }_{{r}_{inner}}^{{r}_{outer}} Δ ( r ) dr}{( {r}_{outer} - {r}_{inner} )} \qquad ( 2 )$$

where rᵢₙₙₑᵣ is the inner radius of the region, rₒᵤₜₑᵣ is the outer radius of the region, and Δ(r) is the relative refractive index of the region.

The term “α-profile” (also referred to as an “alpha profile”) refers to a relative refractive index profile Δ(r) that has the following functional form (3):

$$Δ ( r ) = Δ ( {r}_{0} ) \{ 1 - {[ \frac{\vert r - {r}_{0} \vert}{( {r}_{1} - {r}_{0} )} ]}^{α} \} \qquad ( 3 )$$

where rₒ is the point at which Δ(r) is maximum, r₁ is the point at which Δ(r) is zero, and r is in the range rᵢ≤r≤r_{f}, where rᵢ is the initial point of the α-profile, r_{f} is the final point of the α-profile, and α is a real number. In some embodiments, examples shown herein can have a core alpha of 1≤α≤100. In practice, an actual optical fiber, even when the target profile is an alpha profile, some level of deviation from the ideal configuration can occur. Therefore, the alpha parameter for an optical fiber may be obtained from a best fit of the measured index profile, as is known in the art.

The term “graded-index profile” refers to an α-profile, where α<10. The term “step-index profile” refers to an α-profile, where α≥10.

The “effective area” can be defined as (4):

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 4 )$$

where f(r) is the transverse component of the electric field of the guided optical signal and r is radial position in the fiber. “Effective area” or “A_{eff}” depends on the wavelength of the optical signal. Specific indication of the wavelength will be made when referring to “Effective area” or “A_{eff}” herein. Effective area is expressed herein in units of “μm²”, “square micrometers”, “square microns” or the like.

Unless otherwise noted herein, optical properties (such as dispersion, dispersion slope, etc.) are reported for the LP01 mode.

“Chromatic dispersion,” herein referred to as “dispersion” unless otherwise noted, of an optical fiber is the sum of the material dispersion, the waveguide dispersion, and the intermodal dispersion. “Material dispersion” refers to the manner in which the refractive index of the material used for the optical core affects the velocity at which different optical wavelengths propagate within the core. “Waveguide dispersion” refers to dispersion caused by the different refractive indices of the core and cladding of the optical fiber. In the case of single mode waveguide fibers, the inter-modal dispersion is zero. Dispersion values in a two-mode regime assume intermodal dispersion is zero. The zero-dispersion wavelength (λ₀) is the wavelength at which the dispersion has a value of zero. Dispersion slope is the rate of change of dispersion with respect to wavelength. Dispersion and dispersion slope are reported herein at a wavelength of 1310 nm or 1550 nm, as noted, and are expressed in units of ps/nm/km and ps/nm²/km, respectively. Chromatic dispersion is measured as specified by the IEC 60793-1-42:2013 standard, “Optical fibres—Part 1-42: Measurement methods and test procedures—Chromatic dispersion.”

The cutoff wavelength of an optical fiber is the minimum wavelength at which the optical fiber will support only one propagating mode. For wavelengths below the cutoff wavelength, multimode transmission may occur, and an additional source of dispersion may arise to limit the fiber's information carrying capacity.

Fiber cutoff can be measured by the standard 2 m fiber cutoff test, IEC 60796-1-44 to yield the “fiber cutoff wavelength”, also known as the “2 m fiber cutoff” or “measured cutoff”. The IEC 60796-1-44 standard test is performed to either strip out the higher order modes using a controlled amount of bending, or to normalize the spectral response of the fiber to that of a multimode fiber.

Cable cutoff or cable cutoff wavelength refers to the cable cutoff test specified by the IEC 60796-1-44 standard and is defined as the wavelength at which the second-order modes undergo 19.3 dB more attenuation than the LP01 mode, which is measured on a fiber sample having a length of 22 m with 80 mm diameter loops at both ends.

The bend resistance of an optical fiber, expressed as “bend loss” herein, can be gauged by induced attenuation under prescribed test conditions as specified by the IEC-60793-1-47:2017 standard, “Optical fibres—Part 1-47: Measurement methods and test procedures—Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

The term “attenuation,” as used herein, is the loss of optical power as the signal travels along the optical fiber. Attenuation is measured as specified by the IEC 60793-1-40:2019 standard entitled “Optical fibres—Part 1-40: Attenuation measurement methods.”

An “up-dopant” is a substance added to the glass of the component being studied that has a propensity to raise the refractive index relative to pure undoped silica. A “down-dopant” is a substance added to the glass of the component being studied that has a propensity to lower the refractive index relative to pure undoped silica. Examples of up-dopants include GeO₂ (germania), Al₂O₃, P₂O₅, TiO₂, Cl, Br, and alkali metal oxides, such as K₂O, Na₂O, Li₂O, Cs₂O, Rb₂O, and mixtures thereof. Examples of down-dopants include fluorine and boron.

The mode field diameter (MFD) is measured using the Petermann II method and was determined from:

$$MFD = 2 w \qquad ( 9 )$$

$$w = \frac{{\int }_{0}^{∞} {( f ( r ) )}^{2}}{{\int }_{0}^{∞} {( \frac{d f ( r )}{dr} )}^{2} r dr} \qquad ( 10 )$$

where f(r) is the transverse component of the electric field distribution of the guided light and r is the radial position in the fiber. Unless otherwise specified, “mode field diameter” or “MFD” refers to the mode field diameter at 1310 nm.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the term “substantially free,” when used to describe the concentration and/or absence of a particular up-dopant or down-dopant in a particular portion of the fiber, means that the constituent component is not intentionally added to the fiber. However, the fiber may contain traces of the constituent component as a contaminant or tramp in amounts of less than 0.15 wt. %.

As used herein, the singular forms “a,” “an” and “the” include plural referents unless the context clearly dictates otherwise. Thus, for example, reference to “a” component includes aspects having two or more such components, unless the context clearly indicates otherwise.

### Multicore Optical Fiber

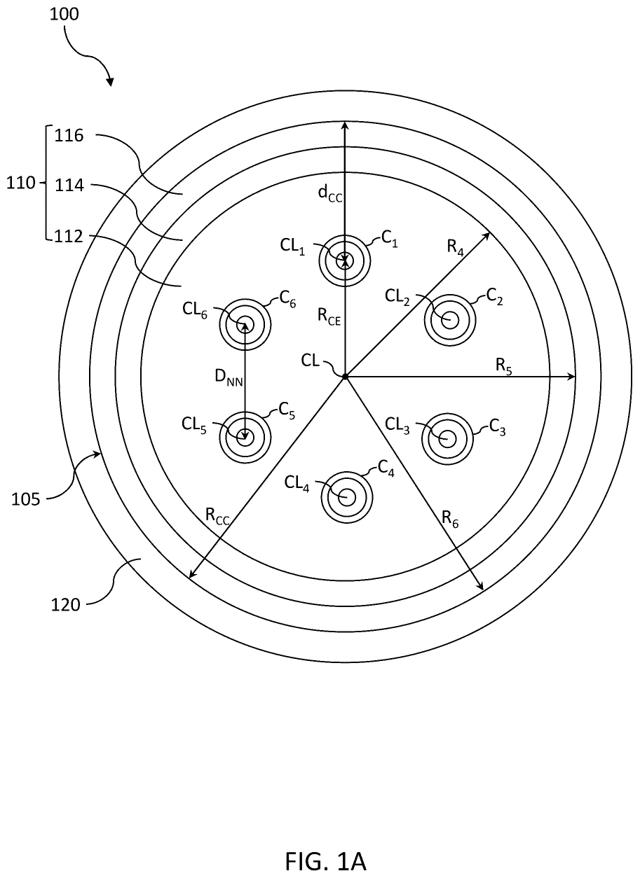

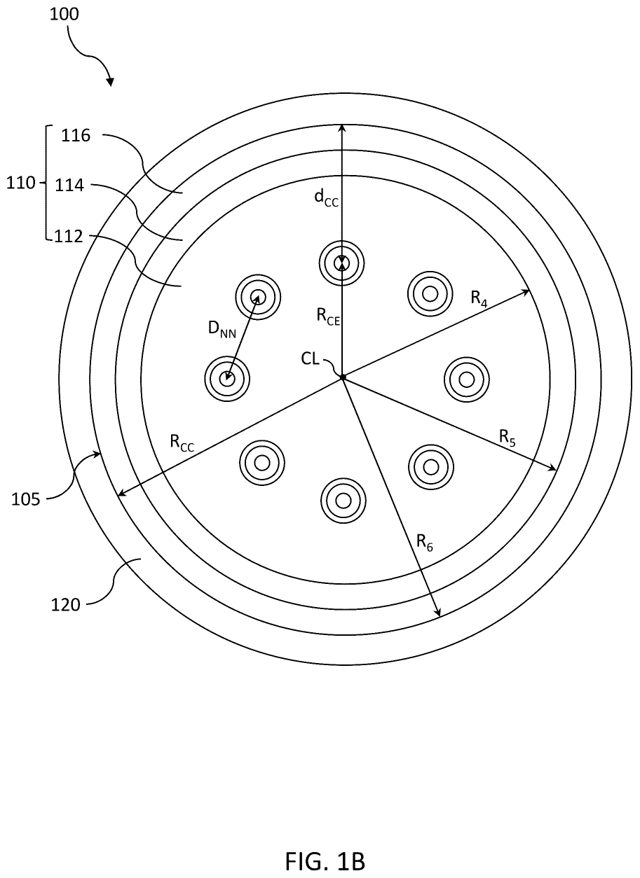

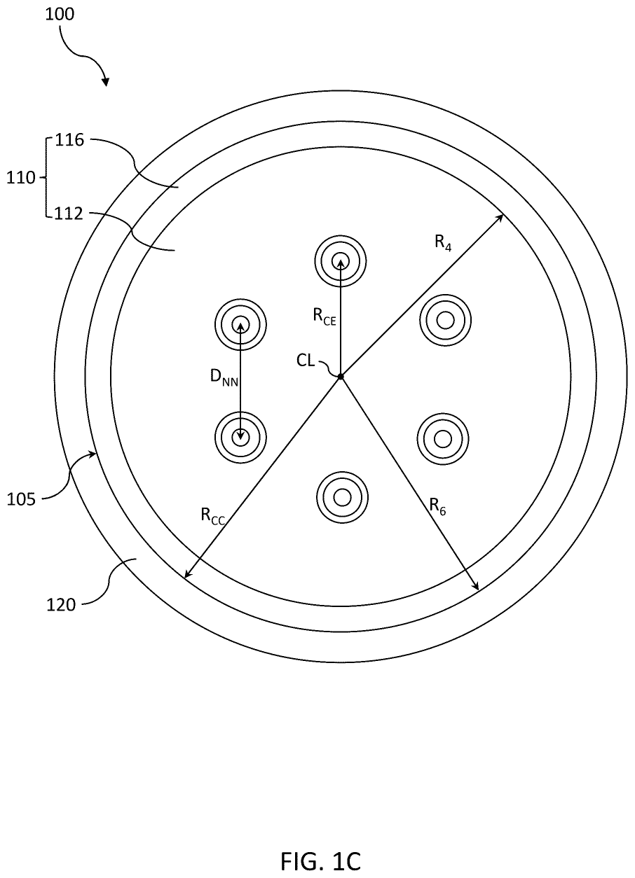

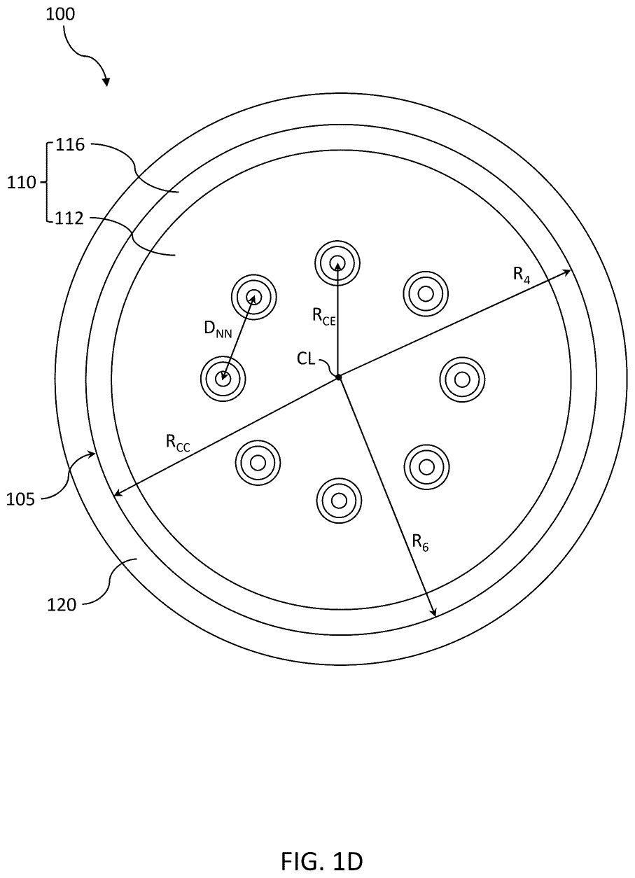

Referring now to FIG. 1A, a cross-sectional view of an exemplary multicore optical fiber 100 is shown. The multicore optical fiber 100 may include a central fiber axis or centerline CL, which defines radial position R=0. As used hereinafter, “radial position” and/or “radial distance,” when used in reference to the radial coordinate “R” refers to radial position relative to the central fiber axis CL (R=0) of the multicore optical fiber. In some embodiments, the multicore optical fiber 100 may include a glass fiber 105, which may include a common cladding 110 and multiple core elements C disposed within the common cladding 110. The centerline CL of the multicore optical fiber 110 may correspond to the centerline of the common cladding 110. The common cladding 110 may include an outer radius R_{CC}, which may correspond to the radius of the glass fiber 105 of the multicore optical fiber 100 in some embodiments.

Each core element Cᵢ may generally extend through a length of the multicore optical fiber 100 parallel to the central fiber axis CL. The core elements C may be individually denoted Cᵢ, such as individually denoted C₁, C₂, C₃, C₄, C₅, and C₆ in the exemplary embodiment shown in FIG. 1A, and collectively referred to as core elements C. While the exemplary embodiment of the multicore optical fiber 100 shown in FIG. 1A includes 6 core elements C, the multicore optical fiber 100 may include other number of core elements C. For example, FIG. 1B schematically illustrates an exemplary multicore optical fiber 100 having 8 core elements C. The multicore optical fiber 100 may include any suitable number of core elements C. For example, the multicore optical fiber 100 may include at least six core elements C—including all sub-ranges or values therebetween. It should be noted that although disclosure will be made in reference to the multicore optical fibers of FIG. 1A and/or FIG. 1B, such disclosure may also be applicable to multicore optical fibers having any suitable number of core elements C as would be appreciated by one skilled in the art.

The multicore optical fiber 100 may further include a non-glass, polymer coating 120 surround and directly contacting the glass fiber portion or the common cladding 110. In some embodiments, the coating 120 may include a primary coating, a secondary coating, and/or a tertiary coating. The central fiber axis CL of the multicore optical fiber 110 may correspond to the centerline of the coating 120. The diameter of the coated multicore optical fiber 100, corresponding to the outer diameter of the coating 120, may be greater than or equal to (i.e., ≥) 190 μm and less than or equal to (i.e., ≤) 250 μm—including all sub-ranges or values therebetween. For example, in embodiments, the diameter of the coated multicore optical fiber 100 may be ≥190 μm and ≤250 μm, ≥190 μm and ≤230 μm, ≥190 μm and ≤210 μm, ≥210 μm and ≤250 μm, ≥210 μm and ≤230 μm, or ≥230 μm and ≤250 μm. In embodiments, the diameter of the coated multicore optical fiber 100 may be greater than or equal to (i.e., ≥) 190 μm, ≥195 μm, ≥200 μm, ≥205 μm, ≥210 μm, ≥215 μm, ≥220 μm, ≥225 μm, ≥230 μm, ≥235 μm, ≥240 μm, ≥245 μm, or greater. In embodiments, the diameter of the coated multicore optical fiber 100 may be less than or equal to (i.e., ≤) 250 μm, ≤245 μm, ≤240 μm, ≤235 μm, ≤230 μm, ≤225 μm, ≤220 μm, ≤215 μm, ≤210 μm, ≤205 μm, ≤200 μm, ≤195 μm, or less.

### Core Element

### R_{CE}

With continued reference to FIGS. 1A and 1B, each core element Cᵢ includes a central axis or centerline CLᵢ, which define radial position r=0 for each core element Cᵢ. As used hereinafter, “radial position” and/or “radial distance,” when used in reference to the radial coordinate “r” refers to radial position relative to the centerline CLᵢ (r=0) of each individual core element in the multicore optical fiber.

In some embodiments, the core elements C may be disposed in an annular region relative to the central fiber axis CL of the multicore optical fiber 100, with the centerline CLᵢ of each core element Cᵢ centered on a circle having a radius R_{CE} from the central fiber axis CL of the multicore optical fiber 100. In some embodiments, all the of the core elements C may be disposed within a single annular region, and no core elements may be disposed outside the annular region. In some embodiments, the core elements C may be disposed symmetrically in the annular region and equally spaced apart along the circumference of the circle having the radius R_{CE}.

In some embodiments, the radius R_{CE} may be greater than or equal to (i.e., ≥) 35 μm and less than or equal to (i.e., ≤) 57 μm—including all sub-ranges or values therebetween. For example, in some embodiments, the radius R_{CE} may be ≥35 μm and ≤57 μm, ≥35 μm and ≤50 μm, ≥35 μm and ≤45 μm, ≥35 μm and ≤40 μm, ≥40 μm and ≤57 μm, ≥40 μm and ≤50 μm, ≥40 μm and ≤45 μm, ≥45 μm and ≤57 μm, ≥45 μm and ≤50 μm, or ≥50 μm and ≤57 μm. In some embodiments, the radius R_{CE} may be greater than or equal to (i.e., ≥) 35 μm, ≥36 μm, ≥37 μm, ≥38 μm, ≥39 μm, ≥40 μm, ≥41 μm, ≥42 μm, ≥43 μm, ≥44 μm, ≥45 μm, ≥46 μm, ≥47 μm, ≥48 μm, ≥49 μm, ≥50 μm, ≥51 μm, ≥52 μm, ≥53 μm, ≥54 μm, ≥55 μm, ≥56 μm, or greater. In some embodiments, the radius R_{CE} may be less than or equal to (i.e., ≤) 57 μm, ≤56 μm, ≤55 μm, ≤54 μm, ≤53 μm, ≤52 μm, ≤51 μm, ≤50 μm, ≤49 μm, ≤48 μm, ≤47 μm, ≤46 μm, ≤45 μm, ≤44 μm, ≤43 μm, ≤42 μm, ≤41 μm, ≤40 μm, ≤39 μm, ≤38 μm, ≤37 μm, ≤36 μm, or less.

d_{CC}

In some embodiments, each core element Cᵢ may be separated from the coating 120 by a core-coating distance d_{CC}, which is defined by the radial distance between the centerline CLᵢ of the core elements Cᵢ and the outer radius R_{CC} of the common cladding 110. In embodiments, the core-coating distance d_{CC} may be greater than or equal to (i.e., ≥) 22 μm and less than or equal to (i.e., ≤) 35 μm—including all sub-ranges or values therebetween. For example, in embodiments, the core-coating distance d_{CC} may be ≥22 μm and ≤35 μm, ≥22 μm and ≤31 μm, ≥22 μm and ≤27 μm, ≥23 μm and ≤35 μm, ≥23 μm and ≤31 μm, ≥23 μm and ≤27 μm, ≥27 μm and ≤35 μm, ≥27 μm and ≤31 μm, or ≥31 μm and ≤35 μm. In embodiments, the core-coating distance d_{CC} may be greater than or equal to (i.e., ≥) 22 μm, ≥23 μm, ≥24 μm, ≥25 μm, ≥26 μm, ≥27 μm, ≥28 μm, ≥29 μm, ≥30 μm, ≥31 μm, ≥32 μm, ≥33 μm, ≥34 μm, or greater. In embodiments, the core-coating distance d_{CC} may be less than or equal to (i.e., ≤) 35 μm, ≤34 μm, ≤33 μm, ≤32 μm, ≤31 μm, ≤30 μm, ≤29 μm, ≤28 μm, ≤27 μm, ≤26 μm, ≤25 μm, ≤24 μm, ≤23 μm, or less.

### D_{NN}

In some embodiments, each core element may be separated from a nearest one by a minimum core-to-core (more specifically, centerline-to-centerline) separation distance, also referred to as the nearest-neighbor separation D_{NN}. As used herein, the term “nearest-neighbor core elements” or “adjacent core elements” is used to denote core elements having centerlines that are most proximate to one another (i.e., there is no other core element having a centerline that is more proximate to a core element than a nearest-neighbor or adjacent core element). Accordingly, centerlines of nearest-neighbor or adjacent core elements are separated by the nearest-neighbor separation D_{NN}. The nearest-neighbor separation D_{NN} may at least in part determine the nearest-neighbor crosstalk value (as will be discussed in more detail below).

In some embodiments, each core element may be separated from multiple core elements by the nearest-neighbor separation D_{NN}. For example, as depicted in FIGS. 1A and 1B, the core elements C may be arranged in an annular region about the central fiber axis CL and equally spaced apart, and each core element Cᵢ may be separated from two nearest or adjacent core elements, e.g., the core element Cᵢ₋₁ and the core element Cᵢ₊₁.

In some embodiments, the nearest-neighbor separation D_{NN} may be greater than or equal to (i.e., ≥) 35 μm and less than or equal to (i.e., ≤) 43 μm—including all sub-ranges or values therebetween. For example, in some embodiments, the nearest-neighbor separation D_{NN} may be ≥35 μm and ≤43 μm, ≥35 μm and ≤41 μm, ≥35 μm and ≤39 μm, ≥35 μm and ≤37 μm, ≥37 μm and ≤43 μm, ≥37 μm and ≤41 μm, ≥37 μm and ≤39 μm, ≥39 μm and ≤43 μm, ≥39 μm and ≤41 μm, or ≥41 μm and ≤43 μm. In some embodiments, the nearest-neighbor separation D_{NN} may be greater than or equal to (i.e., ≥) 35 μm, ≥36 μm, ≥37 μm, ≥38 μm, ≥39 μm, ≥40 μm, ≥41 μm, ≥42 μm, or greater. In some embodiments, the nearest-neighbor separation D_{NN} may be less than or equal to (i.e., ≤) 43 μm, ≤42 μm, ≤41 μm, ≤40 μm, ≤39 μm, ≤38 μm, ≤37 μm, ≤36 μm, or less.

Depending on the number and/or arrangement of the core elements C, the radial distance R_{CE} from the central fiber axis CL to the centerline CLᵢ may depend on the nearest-neighbor separation D_{NN}. For example, in the exemplary six-core multicore optical fiber 100 shown in FIG. 1A, R_{CE}=D_{NN}. In the exemplary eight-core multicore optical fiber 100 shown in FIG. 1B, R_{CE}=D_{NN}/[√(2−√2)]=1.31 D_{NN}.

### Structure

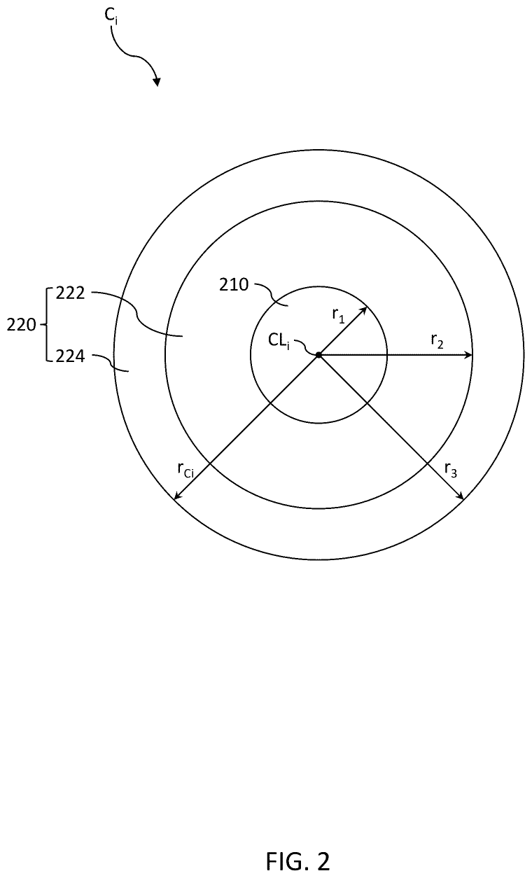

Referring to FIG. 2, a cross-sectional view of an exemplary core element Cᵢ is shown. The core element Cᵢ may include a core region 210 centered on the centerline CLᵢ of the core element Cᵢ, and a dedicated cladding 220 surrounding and directly contacting the core region 210. The common cladding 110 of the multicore optical fiber 100 may surround and directly contact the dedicated cladding 220 of each core element Cᵢ, as shown in FIGS. 1A and 1B. In some embodiments, the dedicated cladding 220 may include a dedicated inner cladding region 222 surrounding and directly contacting the core region 210 and a dedicated outer cladding region 224 surrounding and directly contacting the dedicated inner cladding region 222. In some embodiments, the core region 210, the dedicated inner cladding region 222, and/or the dedicated outer cladding region 224 may be concentric such that the cross section of the core element Cᵢ may be generally circular symmetric with respect to the centerline CLᵢ. In some embodiments, the dedicated outer cladding region 224 may include a depress-index cladding region, also referred to as a trench region. The common cladding 110 of the multicore optical fiber 100 may surround and directly contact the dedicated outer cladding region 224 of each core element Cᵢ.

The core region 210 of the core element Cᵢ may extend from the central axis CLᵢ to a radius r₁. The dedicated inner cladding region 222 may extend from the outer radius r₁ of the core region 210 to an outer radius r₂. The outer radius r₁ of the core region 210 may coincide with the inner radius of the dedicated inner cladding region 222. The dedicated outer cladding region 224 may extend from the outer radius r₂ of the dedicated inner cladding region 222 to an outer radius r₃. The outer radius r₂ of the dedicated inner cladding region 222 may coincide with the inner radius of the dedicated outer cladding region 224. The outer radius r₃ of the dedicated outer cladding region 224 may correspond to the radius r_{Ci} of each core element Cᵢ. The dedicated inner cladding region 222 may include a thickness of r₂−r₁ in the radial direction. The dedicated outer cladding region 224 may include a thickness of r₃−r₂ in the radial direction.

### Refractive Index Profile

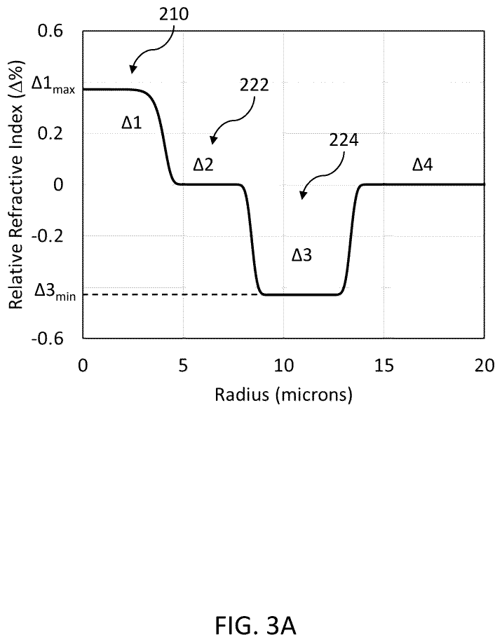

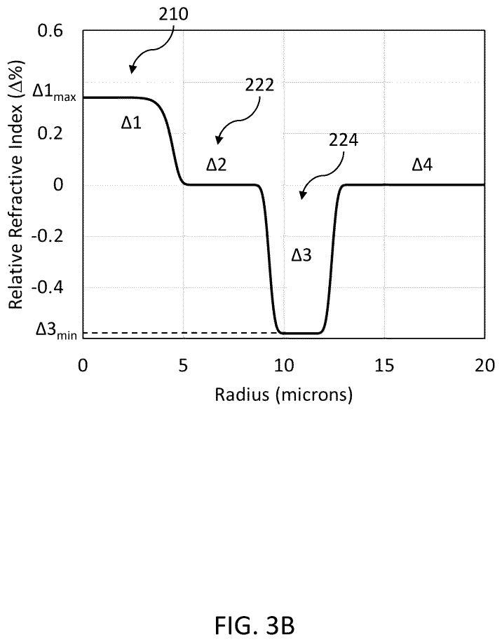

FIG. 3A illustrates an exemplary refractive index profile of the core element Cᵢ, and the portion of common cladding 110 immediately surrounding the core element Cᵢ. FIG. 3B illustrates another exemplary refractive index profile of the core element Cᵢ and the portion of common cladding 110 immediately surrounding the core element Cᵢ. The relative refractive index profiles of the core element Cᵢ are plotted as a function of radial distance r from the centerline CLᵢ of the core element Cᵢ. As illustrated in FIGS. 3A and 3B, the relative refractive index profiles extend radially outward from the centerline CLᵢ of the core element Cᵢ and into a portion of the common cladding 110.

### Core Region

As depicted in FIGS. 3A and 3B, the core region 210 of the core element Cᵢ may include a relative refractive index Δ₁, which may be represented as Δ₁(r). The core region 210 may include silica glass that may be either un-doped silica glass, up-doped silica glass, and/or down-doped silica glass. Up-doped silica glass may include silica glass doped with, for example, germanium (e.g., GeO₂), phosphorus (e.g., P₂O₅), aluminum (e.g., Al₂O₃), chlorine, or an alkali metal oxide (e.g., Na₂O, K₂O, Li₂O, Cs₂O, or Rb₂O). In embodiments where the core may be doped with an alkali dopant, the peak concentration of the alkali in the silica glass may range from about 10 ppm to about 500 ppm, or from about 30 ppm to about 400 ppm. In yet other embodiments, the silica glass of the core region 210 may be free of germanium and/or chlorine; that is the core region 210 may include silica glass that lacks germanium and/or chlorine. Down-doped silica glass may include silica glass doped with, for example, fluorine or boron.

In some embodiments, the relative refractive index Δ₁(r) of the core region 210 may include a maximum relative refractive index Δ₁ₘₐₓ (relative to pure silica) at the centerline CLᵢ, i.e., the radial position r=0. Although not depicted, in some embodiments, the relative refractive index of the core region 210 may have a centerline dip such that the maximum refractive index Δ₁ₘₐₓ of the core region 210 may be located a small distance away from the centerline CLᵢ rather than at the centerline CLᵢ as depicted in FIGS. 3A and 3B.

In some embodiments, the maximum relative refractive index Δ₁ₘₐₓ of the core region 210 may be greater than or equal to (i.e., ≥) 0.33% and less than or equal to (i.e., ≤) 0.40%—including all sub-ranges or values therebetween. In some embodiments, the maximum relative refractive index Δ₁ₘₐₓ of the core region 210 may be ≥0.33% and ≤0.40%, ≥0.33% and ≤0.38%, ≥0.33% and ≤0.36%, ≥0.33% and ≤0.34%, ≥0.35% and ≤0.40%, ≥0.35% and ≤0.38%, ≥0.35% and ≤0.36%, ≥0.37% and ≤0.40%, ≥0.37% and ≤0.38%, or ≥0.39% and ≤0.40%. In some embodiments, the maximum relative refractive index Δ₁ₘₐₓ of the core region 210 may be greater than or equal to (i.e., ≥) 0.33%, ≥0.34%, ≥0.35%, ≥0.36%, ≥0.37%, ≥0.38%, ≥0.39%, or greater. In some embodiments, the maximum relative refractive index Δ₁ₘₐₓ of the core region 210 may be less than or equal to (i.e., ≤) 0.40%, ≤0.39%, ≤0.38%, ≤0.37%, ≤0.36%, ≤0.35%, ≤0.34%, or less.

In some embodiments, the α value of the core region 210 may be greater than or equal to (i.e., ≥) 2 and less than or equal to (i.e., ≤) 20—including all sub-ranges or values therebetween. For example, in some embodiments, the α value may be ≥2 and ≤20, ≥2 and ≤18, ≥2 and ≤16, ≥2 and ≤14, ≥2 and ≤12, ≥2 and ≤10, ≥2 and ≤8, ≥2 and ≤6, ≥6 and ≤20, ≥6 and ≤18, ≥6 and ≤16, ≥6 and ≤14, ≥6 and ≤12, ≥6 and ≤10, ≥6 and ≤8, ≥8 and ≤20, ≥8 and ≤18, ≥8 and ≤16, ≥8 and ≤14, ≥8 and ≤12, ≥8 and ≤10, ≥10 and ≤20, ≥10 and ≤18, ≥0 and ≤16, ≥0 and ≤14, ≥0 and ≤12, 12 and ≤20, 12 and ≤18, 12 and ≤16, ≥12 and ≤14, ≥14 and ≤20, ≥14 and ≤18, ≥14 and ≤16, ≥16 and ≤20, ≥16 and ≤18, or ≥18 and ≤20. In some embodiments, the α value may be less than or equal to (i.e., ≤) 20, ≤19, ≤18, ≤17, ≤16, ≤15, ≤14, ≤13, ≤12, ≤11, ≤10, ≤9, ≤8, ≤7, ≤6, ≤5, ≤4, ≤3, or less. In some embodiments, the α value may be greater than or equal to (i.e., ≥) 2, ≥3, ≥4, ≥5, ≥6, ≥7, ≥8, ≥9, ≥10, ≥11, ≥12, ≥13, ≥14, ≥15, ≥16, ≥17, ≥18, ≥19, or greater.

In some embodiments, the core region 210 may include a step-index profile/shape with α≥10, and the relative refractive index Δ₁ (r) may remain substantially equal to the maximum relative refractive index Δ₁ₘₐₓ until the radius r₁. In some embodiments, the step-index profile/shape may be rounded due to dopant diffusion.

In some embodiments, the core radius r₁ may be greater than or equal to (i.e., ≥) 4 μm and less than or equal to (i.e., ≤) 5 μm—including all sub-ranges or values therebetween. For example, in some embodiments, the core radius r₁ may be ≥4 μm and ≤5 μm, ≥4 μm and ≤4.5 μm, or ≥4.5 μm and ≤5 μm. In some embodiments, the core radius r₁ may be greater than or equal to (i.e., ≥) 4 μm, ≥4.1 μm, ≥4.2 μm, ≥4.3 μm, ≥4.4 μm, ≥4.5 μm, ≥4.6 μm, ≥4.7 μm, ≥4.8 μm, ≥4.9 μm, or greater. In some embodiments, the core radius r₁ may be less than or equal to (i.e., ≤) 5 μm, ≤4.9 μm, ≤4.8 μm, ≤4.7 μm, ≤4.6 μm, ≤4.5 μm, ≤4.4 μm, ≤4.3 μm, ≤4.2 μm, ≤4.1 μm, or less.

### Dedicated Inner Cladding Region

The dedicated inner cladding region 222 of the core element Cᵢ may include a relative refractive index Δ₂, which may be represented as Δ₂(r). In some embodiments, the dedicated inner cladding region 222 may include un-doped silica glass. In some embodiments, the dedicated inner cladding region 222 may include up-doped silica glass and/or down-doped silica glass, doped with any of the up-dopant and/or down-dopant described above to increase and/or decrease its index.

In some embodiments, the relative refractive index Δ₂ of the dedicated inner cladding region 222 may be greater than or equal to (i.e., ≥) −0.05% and less than or equal to (i.e., ≤) 0.05%—including all sub-ranges or values therebetween. For example, in some embodiments, the relative refractive index Δ₂ of the dedicated inner cladding region 222 may be ≥−0.05% and ≤0.05%, ≥−0.05% and ≤0%, or ≥0% and ≤0.05%. In some embodiments, the relative refractive index Δ₂ of the dedicated inner cladding region 222 may be greater than or equal to (i.e., ≥) −0.05%, ≥−0.04%, ≥−0.03%, ≥−0.02%, ≥−0.01%, ≥0%, ≥0.01%, ≥0.02%, ≥0.03%, ≥0.04%, or greater. In some embodiments, the relative refractive index Δ₂ of the dedicated inner cladding region 222 may be less than or equal to (i.e., ≤) 0.05%, ≤0.04%, ≤0.03%, ≤0.02%, ≤0.01%, ≤0%, ≤−0.01%, ≤−0.02%, ≤−0.03%, ≤−0.04%, or less. In some embodiments, the relative refractive index Δ₂ may be about 0.0%. The relative refractive index Δ₂ may be constant or approximately constant.

The inner radius of the dedicated inner cladding region 222 may correspond to the outer radius r₁ of the core region 210, as discussed above. The outer radius r₂ of the dedicated inner cladding region 222 may be greater than or equal to (i.e., ≥) 8 μm and less than or equal to (i.e., ≤) 10.5 μm—including all sub-ranges or values therebetween. For example, in some embodiments, the outer radius r₂ of the dedicated inner cladding region 222 may be ≥8 μm and ≤10.5 μm, ≥8 μm and ≤9.5 μm, ≥8 μm and ≤8.5 μm, ≥9 μm and ≤10.5 μm, ≥9 μm and ≤9.5 μm, or ≥10 μm and ≤10.5 μm. In some embodiments, the outer radius r₂ of the dedicated inner cladding region 222 may be greater than or equal to (i.e., ≥) 8 μm, ≥8.2 μm, ≥8.4 μm, ≥8.6 μm, ≥8.8 μm, ≥9 μm, ≥9.2 μm, ≥9.4 μm, ≥9.6 μm, ≥9.8 μm, ≥10 μm, ≥10.2 μm, ≥10.4 μm, or greater. In some embodiments, the outer radius r₂ of the dedicated inner cladding region 222 may be less than or equal to (i.e., ≤) 10.5 μm, ≤10.3 μm, ≤10.1 μm, ≤9.9 μm, ≤9.7 μm, ≤9.5 μm, ≤9.3 μm, 9.1 μm, ≤8.9 μm, ≤8.7 μm, ≤8.5 μm, ≤8.3 μm, ≤8.1 μm, or less.

A ratio of the core radius r₁ of the core region 210 to the outer radius r₂ of the dedicated inner cladding region 222, r₁/r₂, may be greater than or equal to (i.e., ≥) 0.38 and less than or equal to (i.e., ≤) 0.63—including all sub-ranges or values therebetween. For example, in some embodiments, the ratio of the core radius r₁ of the core region 210 to the outer radius r₂ of the dedicated inner cladding region 222, r₁/r₂, may be ≥0.38 and ≤0.63, ≥0.38 and ≤0.53, ≥0.38 and ≤0.43, ≥0.48 and ≤0.63, ≥0.48 and ≤0.53, or ≥0.58 and ≤0.63. In some embodiments, the ratio of the core radius r₁ of the core region 210 to the outer radius r₂ of the dedicated inner cladding region 222, r₁/r₂, may be greater than or equal to (i.e., ≥) 0.38, ≥0.42, ≥0.46, ≥0.50, ≥0.54, ≥0.58, ≥0.62, or greater. In some embodiments, the ratio of the core radius r₁ of the core region 210 to the outer radius r₂ of the dedicated inner cladding region 222, r₁/r₂, may be less than or equal to (i.e., ≤) 0.63, ≤0.59, ≤0.55, ≤0.51, ≤0.47, ≤0.43, ≤0.39, or less.

The thickness of the dedicated inner cladding region 222, r₂−r₁, may be greater than or equal to (i.e., ≥) 4 μm and less than or equal to (i.e., ≤) 5.5 μm—including all sub-ranges or values therebetween. For example, in some embodiments, the thickness of the dedicated inner cladding region 222, r₂−r₁, may be ≥4 μm and ≤5.5 μm, ≥4 μm and ≤5 μm, ≥4 μm and ≤4.5 μm, ≥4.5 μm and ≤5.5 μm, ≥4.5 μm and ≤5 μm, or ≥5 μm and ≤5.5 μm. In some embodiments, the thickness of the dedicated inner cladding region 222, r₂−r₁, may be greater than or equal to (i.e., ≥) 4 μm, ≥4.2 μm, ≥4.4 μm, ≥4.6 μm, ≥4.8 μm, ≥5 μm, ≥5.2 μm, ≥5.4 μm, or greater. In some embodiments, the thickness of the dedicated inner cladding region 222, r₂−r₁, may be less than or equal to (i.e., ≤) 5.5 μm, ≤5.3 μm, ≤5.1 μm, ≤4.9 μm, ≤4.7 μm, ≤4.5 μm, ≤4.3 μm, ≤4.1 μm, or less.

### Dedicated Outer Cladding Region

The dedicated outer cladding region 224 of the core element Cᵢ may include a relative refractive index Δ₃, which may be represented as Δ₃(r). In some embodiments, the dedicated outer cladding region 224 may include down-doped silica glass. In some embodiments, the dedicated outer cladding region 224 may be down-doped with fluorine or boron. However, the down-doping of the dedicated outer cladding region 224 may also be accomplished by incorporating voids in silica glass.

In some embodiments, the relative refractive index Δ₃ may be less than the relative refractive index Δ₂ of the dedicated inner cladding region 222. In some embodiments, the relative refractive index Δ₃ may also be less than the relative refractive index of the region of the common cladding 110 immediately contacting the dedicated outer cladding region 224 such that the dedicated outer cladding region 224 forms a trench in the relative refractive index profile. The term “trench,” as used herein, refers to a region of the core element that is, in radial cross section, surrounded by regions of the multicore optical fiber 100 (e.g., the dedicated inner cladding region 222 and the common cladding 110) having relatively higher refractive indexes. In some embodiments, the relative refractive index Δ₃ may be constant or substantially constant throughout the dedicated outer cladding region 224. In other embodiments, the relative refractive index Δ₃ may vary with radial coordinate r (radius).

In some embodiments, the relative refractive index Δ₃(r) of the dedicated outer cladding region 224 may include a minimum relative refractive index Δ₃ₘᵢₘ (relative to pure silica). In some embodiments, the minimum relative refractive index Δ₃ₘᵢₙ of the dedicated outer cladding region 224 may be greater than or equal to (i.e., ≥) −0.7% and less than or equal to (i.e., ≤) −0.3%—including all sub-ranges or values therebetween. For example, in some embodiments, the minimum relative refractive index Δ₃ₘᵢₙ may be ≥−0.7% and ≤−0.3%, ≥−0.7% and ≤−0.4%, ≥−0.7% and ≤−0.5%, ≥−0.7% and ≤−0.6%, ≥−0.6% and ≤−0.3%, ≥−0.6% and ≤−0.4%, ≥−0.6% and ≤−0.5%, ≥−0.5% and ≤−0.3%, ≥−0.5% and ≤−0.4%, or ≥−0.4% and ≤−0.3%. In some embodiments, the minimum relative refractive index Δ₃ₘᵢₙ may be greater than or equal to (i.e., ≥) −0.7%, ≥−0.65%, ≥−0.6%, ≥−0.55%, ≥−0.5%, ≥−0.45%, ≥−0.4%, ≥−0.35%, or greater. In some embodiments, the minimum relative refractive index Δ₃ₘᵢₙ may be less than or equal to (i.e., ≤) −0.3%, ≤−0.35%, ≤−0.4%, ≤−0.45%, ≤−0.5%, ≤−0.55%, ≤−0.6%, ≤−0.65%, or less.

As discussed above, the inner radius of the dedicated outer cladding region 224 may correspond to the outer radius r₂ of the dedicated inner cladding region 222. The outer radius r₃ of the dedicated outer cladding region 224 may be greater than or equal to (i.e., ≥) 10 μm and less than or equal to (i.e., ≤) 16.5 μm—including all sub-ranges or values therebetween. For example, in some embodiments, the outer radius r₃ of the dedicated outer cladding region 224 may be ≥10 μm and ≤16.5 μm, ≥10 μm and ≥14.5 μm, ≥10 μm and ≤12.5 μm, ≥10 μm and ≤10.5 μm, ≥12 μm and ≤16.5 μm, ≥12 μm and ≤14.5 μm, ≥12 μm and ≤12.5 μm, ≥14 μm and ≤16.5 μm, ≥14 μm and ≤14.5 μm, or ≥16 μm and ≤16.5 μm. In some embodiments, the outer radius r₃ of the dedicated outer cladding region 224 may be greater than or equal to (i.e., ≥) 10 μm, ≥10.5 μm, ≥11 μm, ≥11.5 μm, ≥12 μm, ≥12.5 μm, ≥13 μm, ≥13.5 μm, ≥14 μm, ≥14.5 μm, ≥15 μm, ≥15.5 μm, ≥16 μm, or greater. In some embodiments, the outer radius r₃ of the dedicated outer cladding region 224 may be less than or equal to (i.e., ≤) 16.5 μm, ≤16 μm, ≤15.5 μm, ≤15 μm, ≤14.5 μm, ≤14 μm, ≤13.5 μm, ≤13 μm, ≤12.5 μm, ≤12 μm, ≤11.5 μm, ≤11 μm, ≤10.5 μm, or less.

In some embodiments, the thickness of the dedicated outer cladding region 224, r₃−r₂, may be greater than or equal to (i.e., ≥) 2 μm and less than or equal to (i.e., ≤) 6 μm—including all sub-ranges or values therebetween. For example, in some embodiments, the thickness of the dedicated outer cladding region 224 may be ≥2 μm and ≤6 μm, ≥2 μm and ≤5 μm, ≥2 μm and ≤4 μm, ≥2 μm and ≤3 μm, ≥3 μm and ≤6 μm, ≥3 μm and ≤5 μm, ≥3 μm and ≤4 μm, ≥4 μm and ≤6 μm, ≥4 μm and ≤5 μm, or ≥5 μm and ≤6 μm. In some embodiments, the thickness of the dedicated outer cladding region 224 may be greater than or equal to (i.e., ≥) 2 μm, ≥2.5 μm, ≥3 μm, ≥3.5 μm, ≥4 μm, ≥4.5 μm, ≥5 μm, ≥5.5 μm, or greater. In some embodiments, the thickness of the dedicated outer cladding region 224 may be less than or equal to (i.e., ≤) 6 μm, ≤5.5 μm, ≤5 μm, ≤4.5 μm, ≤4 μm, ≤3.5 μm, ≤3 μm, ≤2.5 μm, or less.

The radial thickness of a particular glass portion of a core element Cᵢ may be interrelated with a relative refractive index of the particular glass portion. Specifically, a glass portion ‘i’ with a relative refractive index Δᵢ(r), an inner radius rᵢₙ and an outer radius rₒᵤₜ may have a volume Vᵢ defined as:

$${V}_{i} = 2 {\int }_{{r}_{i n}}^{{r}_{out}} {Δ}_{i} ( r ) rdr$$

Accordingly, the dedicated outer cladding region 224 may have a volume V₃ of:

$${V}_{3} = 2 {\int }_{{r}_{2}}^{{r}_{3}} {Δ}_{3} ( r ) rdr$$

which may be rewritten, in some embodiments, as:

$${V}_{3} = {Δ}_{3 min} ( {r}_{3}^{2} - {r}_{2}^{2} )$$

In some embodiments, the dedicated outer cladding region 224 may be constructed to have a down-dopant concentration to achieve a volume V₃ within each core element Cᵢ that may be greater than or equal to (i.e., ≥) −70% Δ-micron² and less than or equal to (i.e., ≤) −30% Δ-micron²—including all sub-ranges or values therebetween. For example, in some embodiments, the dedicated outer cladding region 224 may have a volume V₃≥−70% Δ-micron² and ≤−30% Δ-micron², ≥−70% Δ-micron² and ≤−40% Δ-micron², ≥−70% Δ-micron² and ≤−50% Δ-micron², ≥−70% Δ-micron² and ≤−60% Δ-micron², ≥−60% Δ-micron² and ≤−30% Δ-micron², ≥−60% Δ-micron² and ≤−40% Δ-micron², ≥−60% Δ-micron² and ≤−50% Δ-micron², ≥−50% Δ-micron² and ≤−30% Δ-micron², ≥−50% Δ-micron² and ≤−40% Δ-micron², or ≥−40% Δ-micron² and ≤−30% Δ-micron². In some embodiments, the dedicated outer cladding region 224 may have a volume V₃ greater than or equal to (i.e., ≥) −70% Δ-micron², ≥−65% Δ-micron², ≥−60% Δ-micron², ≥−55% Δ-micron², ≥−50% Δ-micron², ≥−45% Δ-micron², ≥−40% Δ-micron², ≥−35% Δ-micron², or greater. In some embodiments, the dedicated outer cladding region 224 may have a volume V₃ less than or equal to (i.e., ≤) −30% Δ-micron², ≤−35% Δ-micron², ≤−40% Δ-micron², ≤−45% Δ-micron², ≤−50% Δ-micron², ≤−55% Δ-micron², ≤−60% Δ-micron², ≤−65% Δ-micron², or less.

### Core Element Diameter D_{Ci}

Without intending to be bound by theory, the trench design (e.g., relatively large volume) of the dedicated outer cladding region 224 described herein may help isolate the signals propagating in the core elements C of the multicore optical fiber 100. However, the diameter D_{Ci} of each core element Cᵢ, which may be defined by the outer periphery of the dedicated outer cladding region 224 and thus equal to 2×r₃, may not be too large to ensure sufficient separation between the nearest-neighbor core elements to minimize crosstalk and/or to ensure sufficient separation between the core elements and the coating 120 to minimize coating leakage loss. Such separations to minimize crosstalk and/or coating leakage loss may in turn require the core element profile to be radially compact compared to the refractive index profiles of typical bend-insensitive single-mode fibers. Such radially compact profile may require relatively small diameter D_{Ci} of each core element Cᵢ, as well as relatively small thicknesses of the dedicated cladding regions 222, 224 and/or relatively small radius of the core region 210, as described herein.

In some embodiments, the diameters diameter D_{Ci} of each core element Cᵢ=2×r₃ may be greater than or equal to (i.e., ≥) 22 μm and less than or equal to (i.e., ≤) 28 μm—including all sub-ranges or values therebetween. For example, in embodiments, the diameters diameter D_{Ci} of each core element Cᵢ=2×r₃ may be ≥22 μm and ≤28 μm, ≥22 μm and ≤26 μm, ≥22 μm and ≤24 μm, ≥24 μm and ≤28 μm, ≥24 μm and ≤26 μm, or ≥26 μm and ≤28 μm. In embodiments, the diameters diameter D_{Ci} of each core element Cᵢ=2×r₃ may be greater than or equal to (i.e., ≥) 22 μm, ≥22.5 μm, ≥23 μm, ≥23.5 μm, ≥24 μm, ≥24.5 μm, ≥25 μm, ≥25.5 μm, ≥26 μm, ≥26.5 μm, ≥27 μm, ≥27.5 μm, or greater. In embodiments, the diameters diameter D_{Ci} of each core element Cᵢ=2×r₃ may be less than or equal to (i.e., ≤) 28 μm, ≤27.5 μm, ≤27 μm, ≤26.5 μm, ≤26 μm, ≤25.5 μm, ≤25 μm, ≤24.5 μm, ≤24 μm, ≤23.5 μm, ≤23 μm, ≤22.5 μm, or less.

### Mode Field Diameter

In some embodiments, each of the core element Cᵢ described herein may include a mode field diameter (MFD), at 1310 nm wavelength, greater than or equal to (i.e., ≥) 8.6 μm and less than or equal to (i.e., ≤) 9.5 μm—including all sub-ranges or values therebetween. For example, in some embodiments, the core element Cᵢ may include a mode field diameter, at 1310 wavelength, ≥8.6 μm and ≤9.5 μm, ≥8.6 μm and ≤9.2 μm, ≥8.6 μm and ≤8.9 μm, ≥8.9 μm and ≤9.5 μm, ≥8.9 μm and ≤9.2 μm, or ≥9.2 μm and ≤9.5 μm. In some embodiments, the core element Cᵢ described herein may include a mode field diameter, at 1310 nm wavelength, greater than or equal to (i.e., ≥) 8.6 μm, ≥8.7 μm, ≥8.8 μm, ≥8.9 μm, ≥9.0 μm, ≥9.1 μm, ≥9.2 μm, ≥9.3 μm, ≥9.4 μm, or greater. In some embodiments, the core element Cᵢ described herein may include a mode field diameter, at 1310 nm wavelength, less than or equal to (i.e., ≤) 9.5 μm, ≤9.4 μm, ≤9.3 μm, ≤9.2 μm, ≤9.1 μm, ≤9.0 μm, ≤8.9 μm, ≤8.8 μm, ≤8.7 μm, or less.

In some embodiments, each of the core element Cᵢ described herein may include a mode field diameter, at 1550 nm wavelength, greater than or equal to (i.e., ≥) 9.5 μm and less than or equal to (i.e., ≤) 10.5 μm—including all sub-ranges or values therebetween. For example, in some embodiments, the core element Cᵢ described herein may include a mode field diameter, at 1550 nm wavelength, ≥9.5 μm and ≤10.5 μm, ≥9.5 μm and ≤10 μm, or ≥10 μm and ≤10.5 μm. In some embodiments, the core element Cᵢ described herein may include a mode field diameter, at 1550 nm wavelength, greater than or equal to (i.e., ≥) 9.5 μm, ≥9.6 μm, ≥9.7 μm, ≥9.8 μm, ≥9.9 μm, ≥10.0 μm, ≥10.1 μm, ≥10.2 μm, ≥10.3 μm, ≥10.4 μm, or greater. In some embodiments, the core element Cᵢ described herein may include a mode field diameter, at 1550 nm wavelength, less than or equal to (i.e., ≤) 10.5 μm, ≤10.4 μm, ≤10.3 μm, ≤10.2 μm, ≤10.1 μm, ≤10.0 μm, ≤9.9 μm, ≤9.8 μm, ≤9.7 μm, ≤9.6 μm, or less.

### Zero Dispersion Wavelength

The zero dispersion wavelength of the core element Cᵢ described herein may be greater than or equal to (i.e., ≥) 1290 nm and less than or equal to (i.e., ≤) 1320 nm—including all sub-ranges or values therebetween. For example, in some embodiments, the zero dispersion wavelength of the core element Cᵢ described herein may be ≥1290 nm and ≤1320 nm, ≥1290 nm and ≤1310 nm, ≥1290 nm and ≤1300 nm, ≥1300 nm and ≤1320 nm, ≥1300 nm and ≤1310 nm, or ≥1310 nm and ≤1320. In some embodiments, the zero dispersion wavelength of the core element Cᵢ described herein may be greater than or equal to (i.e., ≥) 1290 nm, ≥1295 nm, ≥1300 nm, ≥1305 nm, ≥1310 nm, ≥1315 nm, or greater. In some embodiments, the zero dispersion wavelength of the core element Cᵢ described herein may be less than or equal to (i.e., ≤) 1320 nm, ≤1315 nm, ≤1310 nm, ≤1305 nm, ≤1300 nm, ≤1295 nm, or less.

### Dispersion

The magnitude of the dispersion of the core elements Cᵢ described herein, at 1310 nm wavelength, may be less than or equal to (i.e., ≤) 2.0 ps/nm/km, ≤1.9 ps/nm/km, ≤1.8 ps/nm/km, ≤1.7 ps/nm/km, ≤1.6 ps/nm/km, ≤1.5 ps/nm/km, ≤1.4 ps/nm/km, ≤1.3 ps/nm/km, ≤1.2 ps/nm/km, ≤1.1 ps/nm/km, ≤1.0 ps/nm/km, ≤0.9 ps/nm/km, ≤0.8 ps/nm/km, ≤0.7 ps/nm/km, ≤0.6 ps/nm/km, ≤0.5 ps/nm/km, ≤0.4 ps/nm/km, ≤0.3 ps/nm/km, ≤0.2 ps/nm/km, ≤0.1 ps/nm/km, or less.

### Cutoff Wavelength

In some embodiments, the 22 m cable cutoff wavelength of the core element Cᵢ described herein may be less than or equal to (i.e., ≤) 1260 nm, ≤1250 nm, ≤1240 nm, ≤1230 nm, ≤1220 nm, ≤1210 nm, ≤1200 nm, ≤1190 nm, ≤1180 nm, ≤1170 nm, or less.

In some embodiments, the 2 m fiber cutoff wavelength of the core element Cᵢ described herein may also be less than or equal to (i.e., ≤) 1260 nm, ≤1250 nm, ≤1240 nm, ≤1230 nm, ≤1220 nm, ≤1210 nm, ≤1200 nm, ≤1190 nm, ≤1180 nm, ≤1170 nm, or less.

### Exemplary Core Elements

Tables 1 and 2 provide profile parameters and modeled optical attributes of exemplary core elements.

TABLE 1

| | Ex. 1 | Ex. 2 | Ex. 3 | Ex. 4 | Ex. 5 |
|---|---|---|---|---|---|
| Maximum Relative | 0.37 | 0.35 | 0.37 | 0.37 | 0.37 |
| Refractive Index of Core | | | | | |
| Region, Δ₁ₘₐₓ (%Δ) | | | | | |
| Outer Radius of Core | 4.43 | 4.69 | 4.30 | 4.33 | 4.46 |
| Region, r₁ (μm) | | | | | |
| Alpha of Core Region | 9.07 | 10.74 | 11.32 | 9.81 | 11.38 |
| Relative Refractive Index | 0.0 | 0.0 | 0.0 | 0.0 | 0.0 |
| of Dedicated Inner | | | | | |
| Cladding Region, Δ₂ (%Δ) | | | | | |
| Outer Radius of | 8.74 | 8.87 | 8.41 | 9.57 | 8.53 |
| Dedicated Inner Cladding | | | | | |
| Region, r₂ (μm) | | | | | |
| r₁/r₂ Ratio | 0.51 | 0.53 | 0.51 | 0.45 | 0.52 |
| Thickness of Dedicated | 4.30 | 4.18 | 4.11 | 5.25 | 4.07 |
| Inner Cladding Region, | | | | | |
| r₂ − r₁ (μm) | | | | | |
| Minimum Relative | −0.42 | −0.47 | −0.43 | −0.39 | −0.48 |
| Refractive Index of | | | | | |
| Dedicated Outer Cladding | | | | | |
| Region, Δ₃ₘᵢₙ (%Δ) | | | | | |
| Outer Radius of | 12.20 | 12.49 | 13.34 | 13.68 | 11.67 |
| Dedicated Outer Cladding | | | | | |
| Region, r₃ (μm) | | | | | |
| Thickness of Dedicated | 3.46 | 3.63 | 4.93 | 4.11 | 3.14 |
| Outer Cladding Region, | | | | | |
| r₃ − r₂ (μm) | | | | | |
| Volume of Dedicated | −30.10 | −36.34 | −45.97 | −37.16 | −30.33 |
| Outer Cladding Region, | | | | | |
| V₃ (%Δ-micron²) | | | | | |
| 1310 MFD (μm) | 8.65 | 9.04 | 8.61 | 8.66 | 8.69 |
| 1550 MFD (μm) | 9.63 | 9.97 | 9.56 | 9.73 | 9.61 |
| 1310 Dispersion | 0.89 | 1.77 | 1.04 | 0.15 | 1.47 |
| (ps/nm/km) | | | | | |
| 1310 Dispersion Slope | 0.091 | 0.092 | 0.091 | 0.090 | 0.091 |
| (ps/nm²/km) | | | | | |
| Zero Dispersion | 1300.2 | 1290.7 | 1298.6 | 1308.3 | 1293.9 |
| Wavelength (nm) | | | | | |
| 1550 Dispersion | 18.87 | 19.93 | 19.19 | 17.96 | 19.54 |
| (ps/nm/km) | | | | | |
| 1550 Dispersion Slope | 0.064 | 0.064 | 0.064 | 0.063 | 0.064 |
| (ps/nm²/km) | | | | | |
| 22 m Cable Cutoff | 1180 | 1210 | 1175 | 1180 | 1195 |
| Wavelength (nm) | | | | | |
| 2 m Fiber Cutoff | 1218 | 1250 | 1193 | 1210 | 1240 |
| Wavelength (nm) | | | | | |

TABLE 2

| | Ex. 6 | Ex. 7 | Ex. 8 | Ex. 9 | Ex. 10 |
|---|---|---|---|---|---|
| Maximum Relative | 0.37 | 0.37 | 0.34 | 0.37 | 0.36 |
| Refractive Index of Core | | | | | |
| Region, Δ₁ₘₐₓ (%Δ) | | | | | |
| Outer Radius of Core | 4.46 | 4.40 | 4.72 | 4.46 | 4.43 |
| Region, r₁ (μm) | | | | | |
| Alpha of Core Region | 11.38 | 9.62 | 11.38 | 9.09 | 9.22 |
| Relative Refractive Index | 0.0 | 0.0 | 0.0 | 0.0 | 0.0 |
| of Dedicated Inner | | | | | |
| Cladding Region, Δ₂ (%Δ) | | | | | |
| Outer Radius of | 8.53 | 8.63 | 9.26 | 8.71 | 8.12 |
| Dedicated Inner Cladding | | | | | |
| Region, r₂ (μm) | | | | | |
| r₁/r₂ Ratio | 0.52 | 0.51 | 0.51 | 0.51 | 0.55 |
| Thickness of Dedicated | 4.07 | 4.23 | 4.54 | 4.25 | 3.68 |
| Inner Cladding Region, | | | | | |
| r₂ − r₁ (μm) | | | | | |
| Minimum Relative | −0.64 | −0.63 | −0.58 | −0.66 | −0.61 |
| Refractive Index of | | | | | |
| Dedicated Outer Cladding | | | | | |
| Region, Δ₃ₘᵢₙ (%Δ) | | | | | |
| Outer Radius of | 11.20 | 11.80 | 12.39 | 12.88 | 12.42 |
| Dedicated Outer Cladding | | | | | |
| Region, r₃ (μm) | | | | | |
| Thickness of Dedicated | 2.67 | 3.17 | 3.12 | 4.18 | 4.30 |
| Outer Cladding Region, | | | | | |
| r₃ − r₂ (μm) | | | | | |
| Volume of Dedicated | −33.63 | −40.64 | −39.00 | −59.81 | −53.56 |
| Outer Cladding Region, | | | | | |
| V₃ (%Δ-micron²) | | | | | |
| 1310 MFD (μm) | 8.67 | 8.60 | 9.14 | 8.67 | 8.62 |
| 1550 MFD (μm) | 9.56 | 9.53 | 10.09 | 9.58 | 9.48 |
| 1310 Dispersion | 1.69 | 1.25 | 1.76 | 1.35 | 1.81 |
| (ps/nm/km) | | | | | |
| 1310 Dispersion Slope | 0.092 | 0.092 | 0.092 | 0.092 | 0.093 |
| (ps/nm²/km) | | | | | |
| Zero Dispersion | 1291.7 | 1296.4 | 1290.8 | 1295.3 | 1290.6 |
| Wavelength (nm) | | | | | |
| 1550 Dispersion | 19.90 | 19.52 | 19.97 | 19.75 | 20.26 |
| (ps/nm/km) | | | | | |
| 1550 Dispersion Slope | 0.064 | 0.065 | 0.064 | 0.065 | 0.065 |
| (ps/nm²/km) | | | | | |
| 22 m Cable Cutoff | 1195 | 1180 | 1215 | 1200 | 1175 |
| Wavelength (nm) | | | | | |
| 2 m Fiber Cutoff | 1237 | 1210 | 1255 | 1211 | 1188 |
| Wavelength (nm) | | | | | |

### Common Cladding

Referring back to FIGS. 1A and 1B, in some embodiments, the common cladding 110 may include an inner common cladding region 112 surrounding and directly contacting the core elements C, a depressed index common cladding region 114 surrounding and directly contacting the inner common cladding region 112, and an outer common cladding region 116 surrounding and directly contacting the depressed index common cladding region 114. In some embodiments, the inner common cladding region 112, the depressed index common cladding region 114, and/or the outer common cladding region 116 may be concentric such that the cross section of the common cladding 110 may be generally circular symmetric with respect to the central fiber axis CL of the multicore optical fiber 100. In some embodiments, the common cladding 110 may not include the depressed index common cladding region 114. Accordingly, the outer common cladding region 116 may surround and directly contact the inner common cladding region 112, such as shown in FIGS. 1C and 1D.

The inner common cladding region 112 may extend from the central fiber axis CL to an outer radius R₄. The depressed index common cladding region 114 may extend from the outer radius R₄ of the inner common cladding region 112 to an outer radius R₅. The outer radius R₄ of the inner common cladding region 112 may coincide with the inner radius of the depressed index common cladding region 114. The outer common cladding region 116 may extend from the outer radius R₅ of the depressed index common cladding region 114 to an outer radius R₆. The outer radius R₅ of the depressed index common cladding region 114 may coincide with the inner radius of the outer common cladding region 116. The outer radius R₆ of the outer common cladding region 116 may correspond to the outer radius R_{CC} of the common cladding 110. The depressed index common cladding region 114 may include a thickness of R₅−R₄ in the radial direction. The outer common cladding region 116 may include a thickness of R₆−R₅ in the radial direction.

### Inner Common Cladding

In some embodiments, the inner common cladding region 112 may include un-doped silica glass. In some embodiments, the inner common cladding region 112 may include up-doped silica glass and/or down-doped silica glass, doped with any of the up-dopant and/or down-dopant described above to increase and/or decrease its index.

The inner common cladding region 112 may include a relative refractive index D₄. In some embodiments, the relative refractive index D₄ of the inner common cladding region 112 may be greater than or equal to (i.e., ≥) −0.05% and less than or equal to (i.e., ≤) 0.05%—including all sub-ranges or values therebetween. For example, in some embodiments, the relative refractive index D₄ of the inner common cladding region 112 may be ≥−0.05% and ≤0.05%, ≥−0.05% and ≤0%, or ≥0% and ≤0.05%. In some embodiments, the relative refractive index D₄ of the inner common cladding region 112 may be greater than or equal to (i.e., ≥) −0.05%, ≥−0.04%, ≥−0.03%, ≥−0.02%, ≥−0.01%, ≥0%, ≥0.01%, ≥0.02%, ≥0.03%, ≥0.04%, or greater. In some embodiments, the relative refractive index D₄ of the inner common cladding region 112 may be less than or equal to (i.e., ≤) 0.05%, ≤0.04%, ≤0.03%, ≤0.02%, ≤0.01%, ≤0%, ≤−0.01%, ≤−0.02%, ≤−0.03%, ≤−0.04%, or less. In some embodiments, the relative refractive index D₄ may be about 0.0%. The relative refractive index D₄ may be constant or approximately constant.

In some embodiments, the radius R₄ of the inner common cladding region 112 may be greater than or equal to (i.e., ≥) 55 μm and less than or equal to (i.e., ≤) 80 μm—including all sub-ranges or values therebetween. For example, in embodiments, the radius R₄ of the inner common cladding region 112 may be ≥55 μm and ≤80 μm, ≥55 μm and ≤75 μm, ≥55 μm and ≤70 μm, ≥55 μm and ≤65 μm, ≥55 μm and ≤60 μm, ≥60 μm and ≤80 μm, ≥60 μm and ≤75 μm, ≥60 μm and ≤70 μm, ≥60 μm and ≤65 μm, ≥65 μm and ≤80 μm, ≥65 μm and ≤75 μm, ≥65 μm and ≤70 μm, ≥70 μm and ≤80 μm, ≥70 μm and ≤75 μm, or ≥75 μm and ≤80 μm. In embodiments, the radius R₄ of the inner common cladding region 112 may be greater than or equal to (i.e., ≥) 55 μm, ≥57 μm, ≥59 μm, ≥61 μm, ≥63 μm, ≥65 μm, ≥67 μm, ≥69 μm, ≥71 μm, ≥73 μm, ≥75 μm, ≥77 μm, ≥79 μm, or greater. In embodiments, the radius R₄ of the inner common cladding region 112 may be less than or equal to (i.e., ≤) 80 μm, ≤78 μm, ≤76 μm, ≤74 μm, ≤72 μm, ≤70 μm, ≤68 μm, ≤66 μm, ≤64 μm, ≤62 μm, ≤60 μm, ≤58 μm, ≤56 μm, or less.

### Depressed Index Common Cladding

The depressed index common cladding region 114 of the core element Cᵢ may include a relative refractive index D₅. In some embodiments, the depressed index common cladding region 114 may include down-doped silica glass. In some embodiments, the depressed index common cladding region 114 may be down-doped with fluorine. However, the down-doping of the depressed index common cladding region 114 may also be accomplished by incorporating boron or voids in silica glass.

In some embodiments, the relative refractive index D₅ may be less than the relative refractive index D₄ of the inner common cladding region 112. In some embodiments, the relative refractive index D₅ may also be less than the relative refractive index D₆ of the outer common cladding region 116. Without intending to be bound by theory, the depressed index common cladding region 114 may inhibit leakage of the optical signals from the core elements C into the high index outer common cladding region 116.

In some embodiments, the relative refractive index D₅ may be constant or substantially constant throughout the depressed index common cladding region 114. In other embodiments, the relative refractive index D₅ may vary with radial coordinate R (radius). In some embodiments, the relative refractive index D₅ of the depressed index common cladding region 114 may include a minimum relative refractive index D₅ₘᵢₘ (relative to pure silica). In some embodiments, the minimum relative refractive index D₅ₘᵢₙ of the depressed index common cladding region 114 may be greater than or equal to (i.e., ≥) −0.5% and less than or equal to (i.e., ≤) −0.2%—including all sub-ranges or values therebetween. For example, in some embodiments, the minimum relative refractive index D₅ₘᵢₙ may be ≥−0.5% and ≤−0.2%, ≥−0.5% and ≤−0.3%, ≥−0.5% and ≤−0.4%, ≥−0.4% and ≤−0.2%, ≥−0.4% and ≤−0.3%, or ≥−0.3% and ≤−0.2%. In some embodiments, the minimum relative refractive index D₅ₘᵢₙ may be greater than or equal to (i.e., ≥) −0.5%, ≥−0.45%, ≥−0.4%, ≥−0.35%, ≥−0.3%, ≥−0.25%, or greater. In some embodiments, the minimum relative refractive index D₅ₘᵢₙ may be less than or equal to (i.e., ≤) −0.2%, ≤−0.25%, ≤−0.3%, ≤−0.35%, ≤−0.4%, ≤−0.45%, or less.

As discussed above, the inner radius of the depressed index common cladding region 114 may correspond to the outer radius R₄ of the inner common cladding region 112. The outer radius R₅ of the depressed index common cladding region 114 may be greater than or equal to (i.e., ≥) 55 μm and less than or equal to (i.e., ≤) 85 μm—including all sub-ranges or values therebetween. For example, in embodiments, the outer radius R₅ of the depressed index common cladding region 114 may be ≥55 μm and ≤85 μm, ≥55 μm and ≤80 μm, ≥55 μm and ≤75 μm, ≥55 μm and ≤70 μm, ≥55 μm and ≤65 μm, ≥55 μm and ≤60 μm, ≥60 μm and ≤85 μm, ≥60 μm and ≤80 μm, ≥60 μm and ≤75 μm, ≥60 μm and ≤70 μm, ≥60 μm and ≤65 μm, ≥65 μm and ≤85 μm, ≥65 μm and ≤80 μm, ≥65 μm and ≤75 μm, ≥65 μm and ≤70 μm, ≥70 μm and ≤85 μm, ≥70 μm and ≤80 μm, ≥70 μm and ≤75 μm, ≥75 μm and ≤85 μm, ≥75 μm and ≤80 μm, or ≥80 μm and ≤85 μm. In embodiments, the outer radius R₅ of the depressed index common cladding region 114 may be greater than or equal to (i.e., ≥) 55 μm, ≥56 μm, ≥57 μm, ≥58 μm, ≥59 μm, ≥60 μm, ≥61 μm, ≥62 μm, ≥63 μm, ≥64 μm, ≥65 μm, ≥66 μm, ≥67 μm, ≥68 μm, ≥69 μm, ≥70 μm, ≥71 μm, ≥72 μm, ≥73 μm, ≥74 μm, ≥75 μm, ≥76 μm, ≥77 μm, ≥78 μm, ≥79 μm, ≥80 μm, ≥81 μm, ≥82 μm, ≥83 μm, ≥84 μm, or greater. In embodiments, the outer radius R₅ of the depressed index common cladding region 114 may be less than or equal to (i.e., ≤) 85 μm, ≤84 μm, ≤83 μm, ≤82 μm, ≤81 μm, ≤80 μm, ≤79 μm, ≤78 μm, ≤77 μm, ≤76 μm, ≤75 μm, ≤74 μm, ≤73 μm, ≤72 μm, ≤71 μm, ≤70 μm, ≤69 μm, ≤68 μm, ≤67 μm, ≤66 μm, ≤65 μm, ≤64 μm, ≤63 μm, ≤62 μm, ≤61 μm, ≤60 μm, ≤59 μm, ≤58 μm, ≤57 μm, ≤56 μm, or less.

In some embodiments, the thickness of the depressed index common cladding region 114, t_{DI}=R₅−R₄, may be greater than or equal to (i.e., ≥) 2 μm and less than or equal to (i.e., ≤) 6 μm—including all sub-ranges or values therebetween. For example, in some embodiments, the thickness of the depressed index common cladding region 114 may be ≥2 μm and ≤6 μm, ≥2 μm and ≤5 μm, ≥2 μm and ≤4 μm, ≥2 μm and ≤3 μm, ≥3 μm and ≤6 μm, ≥3 μm and ≤5 μm, ≥3 μm and ≤4 μm, ≥4 μm and ≤6 μm, ≥4 μm and ≤5 μm, or ≥5 μm and ≤6 μm. In some embodiments, the thickness of the depressed index common cladding region 114 may be greater than or equal to (i.e., ≥) 2 μm, ≥2.5 μm, ≥3 μm, ≥3.5 μm, ≥4 μm, ≥4.5 μm, ≥5 μm, ≥5.5 μm, or greater. In some embodiments, the thickness of the depressed index common cladding region 114 may be less than or equal to (i.e., ≤) 6 μm, ≤5.5 μm, ≤5 μm, ≤4.5 μm, ≤4 μm, ≤3.5 μm, ≤3 μm, ≤2.5 μm, or less.

### Outer Common Cladding

As discussed above, the inner radius of the outer common cladding region 116 may correspond to the outer radius R₅ of the depressed index common cladding region 114. The outer radius R₆ of the outer common cladding region 116 may be greater than or equal to (i.e., ≥) 63 μm and less than or equal to (i.e., ≤) 90 μm—including all sub-ranges or values therebetween. For example, in some embodiments, the outer radius R₆ of the outer common cladding region 116 may be ≥63 μm and ≤90 μm, ≥63 μm and ≤80 μm, ≥63 μm and ≤70 μm, ≥75 μm and ≤90 μm, ≥75 μm and ≤80 μm, or ≥85 μm and ≤90 μm. In some embodiments, the outer radius R₆ of the outer common cladding region 116 may be greater than or equal to (i.e., ≥) 63 μm, ≥65 μm, ≥67 μm, ≥69 μm, ≥71 μm, ≥73 μm, ≥75 μm, ≥77 μm, ≥79 μm, ≥81 μm, ≥83 μm, ≥85 μm, ≥87 μm, ≥89 μm, or greater. In some embodiments, the outer radius R₆ of the outer common cladding region 116 may be less than or equal to (i.e., ≤) 90 μm, ≤88 μm, ≤86 μm, ≤84 μm, ≤82 μm, ≤80 μm, ≤78 μm, ≤76 μm, ≤74 μm, ≤72 μm, ≤70 μm, ≤68 μm, ≤66 μm, ≤64 μm, or less.

In some embodiments, the thickness of the outer common cladding region 116, t_{OC}=R₆−R₅, may be greater than or equal to (i.e., ≥) 1 μm and less than or equal to (i.e., ≤) 6 μm—including all sub-ranges or values therebetween. For example, in some embodiments, the thickness of the outer common cladding region 116 may be ≥1 μm and ≤6 μm, ≥1 μm and ≤5 μm, ≥1 μm and ≤4 μm, ≥1 μm and ≤3 μm, ≥1 μm and ≤2 μm, ≥2 μm and ≤6 μm, ≥2 μm and ≤5 μm, ≥2 μm and ≤4 μm, ≥2 μm and ≤3 μm, ≥3 μm and ≤6 μm, ≥3 μm and ≤5 μm, ≥3 μm and ≤4 μm, ≥4 μm and ≤6 μm, ≥4 μm and ≤5 μm, or ≥5 μm and ≤6 μm. In some embodiments, the thickness of the outer common cladding region 116 may be greater than or equal to (i.e., ≥) 1 μm, ≥1.5 μm, ≥2 μm, ≥2.5 μm, ≥3 μm, ≥3.5 μm, ≥4 μm, ≥4.5 μm, ≥5 μm, ≥5.5 μm, or greater. In some embodiments, the thickness of the outer common cladding region 116 may be less than or equal to (i.e., ≤) 6 μm, ≤5.5 μm, ≤5 μm, ≤4.5 μm, ≤4 μm, ≤3.5 μm, ≤3 μm, ≤2.5 μm, ≤2 μm, ≤1.5 μm, or less.

As discussed above, the outer radius R₆ of the outer common cladding region 116 may correspond to the outer radius R_{CC} of the common cladding 110 which may also correspond to the glass fiber 105 of the multicore optical fiber 100 without any coating. Thus, in some embodiments, the outer diameter of the common cladding 110 or the diameter of the glass fiber 105 of the multicore optical fiber 100, i.e., 2×R₆=2×R_{CC}, may be greater than or equal to (i.e., ≥) 126 μm and less than or equal to (i.e., ≤) 180—including all sub-ranges or values therebetween. For example, in some embodiments, the outer diameter of the common cladding 110 or the diameter of the glass fiber 105 of the multicore optical fiber 100 may be ≥126 μm and ≤180 μm, ≥126 μm and ≤170 μm, ≥126 μm and ≤160 μm, ≥126 μm and ≤150 μm, ≥126 μm and ≤145 μm, ≥126 μm and ≤140 μm, ≥126 μm and ≤130 μm, ≥130 μm and ≤180 μm, ≥130 μm and ≤170 μm, ≥130 μm and ≤160 μm, ≥130 μm and ≤150 μm, ≥130 μm and ≤145 μm, ≥130 μm and ≤140 μm, ≥140 μm and ≤180 μm, ≥140 μm and ≤170 μm, ≥140 μm and ≤160 μm, ≥140 μm and ≤150 μm, ≥140 μm and ≤145 μm, ≥150 μm and ≤180 μm, ≥150 μm and ≤170 μm, ≥150 μm and ≤160 μm, ≥160 μm and ≤180 μm, or ≥160 μm and ≤170 μm.

In some embodiments, the outer diameter of the common cladding 110 or the diameter of the glass fiber 105 of the multicore optical fiber 100 may be greater than or equal to (i.e., ≥) 126 μm, ≥130 μm, ≥135 μm, ≥140 μm, ≥145 μm, ≥150 μm, ≥155 μm, ≥160 μm, ≥165 μm, ≥170 μm, ≥175 μm, or greater. In some embodiments, the outer diameter of the common cladding 110 or the diameter of the glass fiber 105 of the multicore optical fiber 100 may be less than or equal to (i.e., ≤) 180 μm, ≤175 μm, ≤170 μm, ≤165 μm, ≤160 μm, ≤155 μm, ≤≤150 μm, ≤≤145 μm, ≤≤140 μm, ≤≤135 μm, ≤≤130 μm, or less.

### Reduced Crosstalk

Compared to multicore optical fibers with a 125 μm silica-cladding diameter, the increased cladding diameter R_{CC} of the multicore optical fiber 100 described herein may allow increased nearest-neighbor separation distance D_{NN} to be implemented. The increased nearest-neighbor separation D_{NN} may in turn reduce the crosstalk among the core elements. A key parameter in multicore optical fibers is the crosstalk between adjacent core elements, which needs to be sufficiently small to ensure good system performance in a multicore optical fiber designed for data transmission. The crosstalk at least in part depends on the distance between the centers of the nearest-neighbor core elements, or the nearest-neighbor separation D_{NN}, as well as the fiber length.

For the multicore optical fiber described herein, the average nearest-neighbor crosstalk at wavelength λ between any two nearest-neighbor core elements with a nearest-neighbor separation D_{NN} can be calculated from the following:

$${XT}_{NN} \approx {κ}^{2} L * ( λ {R}_{b} / π {n}_{eff} {D}_{NN} )$$

where κ is the mode-coupling coefficient, L is the fiber length, n_{eff} is the effective index of refraction of the core element, and R_{b} is the average fiber bend radius, which is taken to be 1 m, based on T. Hayashi et al., “125-μm-Cladding Eight-Core Multi-Core Fiber Realizing Ultra-High-Density Cable Suitable for O-Band Short-Reach Optical Interconnects,” J. Lightwave Technol. 34, pp. 85-92 (Jan. 1, 2016), the content of which is incorporated herein by reference.

The crosstalk from second nearest neighbors (XT_{2NN}) scales as (XT_{NN})²:

$${XT}_{2 NN} \approx {( {XT}_{NN} )}^{2} / 2$$

which is much lower than the crosstalk between nearest neighbor waveguides.

The Hayashi article discussed above provides guidance for suitable levels of crosstalk XT_{NN} and/or coating leakage loss LL_{C} (discussed in more detail below), but the authors were only able to optimize a design with low values of these attributes at 1310 nm due to constraining the cladding diameter to be 125 μm. The corresponding crosstalk XT_{NN} and/or coating leakage loss LL_{C} values at 1550 nm are far too large for the design described therein to be functional for optical communications.

In contrast, the increased cladding diameter of the multicore optical fiber 100 described herein allows significantly lower crosstalk XT_{NN} to be achieved at 1550 nm wavelength. In some embodiments, the crosstalk between nearest-neighbor core elements at 1550 nm may be less than or equal to −30 dB, less than or equal to −35 dB, or less than or equal to −40 dB, as measured for a 100 km length of the multicore optical fiber 100 described herein.

Based on the plots in FIG. 3(c) of the Hayashi article cited above, the dependence of XT_{NN} and XT_{2NN} on the nearest neighbor separation D_{NN} can be derived, based on which the XT_{NN} and XT_{2NN} at the wavelength of 1550 nm can be determined using the following:

$${XT}_{NN} ( dB ) = - 2 \text{.38} {D}_{NN} + 57.6$$

$${XT}_{2 NN} ( dB ) = - 5.0 \; 85 {D}_{NN} + 123.6$$

### Low Coating Leakage Loss

When compared to fibers with a 125 μm silica-cladding diameter, the increased cladding diameter R_{CC} of the multicore optical fiber 100 described herein may further allow increased core-coating distance d_{CC} to be implemented. The increased core-coating distance d_{CC} may in turn reduce the coating leakage loss LL_{C} from the core elements.

Based on the plots in FIG. 3(c) of the Hayashi article, the coating leakage loss LL_{C} due to power coupling from each core element to the high refractive index coating 120 and/or the outer common cladding region 116, at the wavelength of 1550 nm, can be determined by the following:

$${LL}_{C} ( dB / km ) = 1 {0}^{- 0.27 dcc} + 5$$

where d_{CC} is the core-coating distance discussed above, i.e., the radial distance between the centerline CLᵢ of the core element and the outer radius R_{CC} of the common cladding 110. In some embodiments, for the multicore optical fiber 100 described herein, the coating leakage loss LL_{C} may be less than or equal to 0.1 dB/km, less than or equal to 0.05 dB/km, or less than or equal to 0.01 dB/km, at the wavelength of 1550 nm.

It should be noted that the multicore optical fiber 100 described herein may achieve the reduced crosstalk and/or the low coating leakage loss while still maintaining a large mode field diameter and/or low cutoff wavelengths as discussed above. For example, the mode field diameter of the core element at 1550 nm may be greater than or equal to (i.e., ≥) 9.6 μm, preferably ≥9.9 μm, or even more preferably ≥10.2 μm. The 22 m cable cutoff wavelength may be less than 1260 nm, and in some embodiments, the 2 m fiber cutoff may also be less than 1260 nm.

### TiO₂ Doping

In some embodiments, the outer common cladding region 116 may be doped with titania (TiO₂). Without indending to be bound by theory, TiO₂ doping may reduce the Young's modulus of the outer common cladding region 116, which may in turn reduce the stress created in bending, thereby allowing a greater common cladding radius R_{CC} such as described herein to be implemented. Specifically, by incorporating the TiO₂-doped outer common cladding region 116, the allowable bend stress over 5 years at the surface of the glass fiber 105 (or the surface of the common cladding 110) of the multicore optical fiber 100 described herein may be equal to or greater than that of a conventional multicore optical fiber having a 125 μm silica cladding. In other words, the multicore optical fiber 100 described herein not only reduces crosstalk and/or lowers coating leakage loss but also achieve superior mechanical reliability when compared to conventional multicore optical fibers with a 125 μm silica-cladding diameter.

In some embodiments, the outer common cladding region 116 may be doped with a TiO₂ concentration that may be greater than or equal to (i.e., ≥) 0.2 mol % and less than or equal to (i.e., ≤) 11 mol %—including all sub-ranges or values therebetween. For example, in some embodiments, the TiO₂ concentration in the outer common cladding region 116 may be ≥0.2 mol % and ≤11 mol %, ≥0.2 mol % and ≤9 mol %, ≥0.2 mol % and ≤7 mol %, ≥0.2 mol % and ≤5 mol %, ≥0.2 mol % and ≤3 mol %, ≥0.2 mol % and ≤1 mol %, ≥1 mol % and ≤11 mol %, ≥1 mol % and ≤9 mol %, ≥1 mol % and ≤7 mol %, ≥1 mol % and ≤5 mol %, ≥1 mol % and ≤3 mol %, ≥3 mol % and ≤11 mol %, ≥3 mol % and ≤9 mol %, ≥3 mol % and ≤7 mol %, ≥3 mol % and ≤5 mol %, ≥5 mol % and ≤11 mol %, ≥5 mol % and ≤9 mol %, ≥5 mol % and ≤7 mol %, ≥7 mol % and ≤11 mol %, ≥7 mol % and ≤9 mol %, or ≥9 mol % and ≤11 mol %. In some embodiments, the TiO₂ concentration in the outer common cladding region 116 may be greater than or equal to (i.e., ≥) 0.2 mol %, ≥0.5 mol %, ≥1 mol %, ≥1.5 mol %, ≥2 mol %, ≥2.5 mol %, ≥3 mol %, ≥3.5 mol %, ≥4 mol %, ≥4.5 mol %, ≥5 mol %, ≥5.5 mol %, ≥6 mol %, ≥6.5 mol %, ≥7 mol %, ≥7.5 mol %, ≥8 mol %, ≥8.5 mol %, ≥9 mol %, ≥9.5 mol %, ≥10 mol %, ≥10.5 mol %, or greater. In some embodiments, the TiO₂ concentration in the outer common cladding region 116 may be less than or equal to (i.e., ≤) 11 mol %, ≤10.5 mol %, ≤10 mol %, ≤9.5 mol %, ≤9 mol %, ≤8.5 mol %, ≤8 mol %, ≤7.5 mol %, ≤7 mol %, ≤6.5 mol %, ≤6 mol %, ≤5.5 mol %, 5 mol %, ≤4.5 mol %, ≤4 mol %, ≤3.5 mol %, ≤3 mol %, ≤2.5 mol %, ≤2 mol %, ≤1.5 mol %, ≤1 mol %, ≤0.5 mol %, or less.

As additional non-limiting examples, in some embodiments, such as the six-core multicore optical fiber 100 shown in FIGS. 1A and 1C, the TiO₂ concentration in the outer common cladding region 116 may be greater than or equal to (i.e., ≥) 0.2 mol % and less than or equal to (i.e., ≤) 11 mol %—including all sub-ranges or values therebetween. For example, the TiO₂ concentration in the outer common cladding region 116 may be ≥0.2 mol % and ≤11 mol %, ≥0.2 mol % and ≤9 mol %, ≥0.2 mol % and ≤7 mol %, ≥0.2 mol % and ≤5 mol %, ≥0.2 mol % and ≤3 mol %, ≥0.2 mol % and ≤1 mol %, ≥1 mol % and ≤11 mol %, ≥1 mol % and ≤9 mol %, ≥1 mol % and ≤7 mol %, ≥1 mol % and ≤5 mol %, ≥1 mol % and ≤3 mol %, ≥3 mol % and ≤11 mol %, ≥3 mol % and ≤9 mol %, ≥3 mol % and ≤7 mol %, ≥3 mol % and ≤5 mol %, ≥5 mol % and ≤11 mol %, ≥5 mol % and ≤9 mol %, ≥5 mol % and ≤7 mol %, ≥7 mol % and ≤11 mol %, ≥7 mol % and ≤9 mol %, or ≥9 mol % and ≤11 mol %. In some embodiments, the TiO₂ concentration in the outer common cladding region 116 may be greater than or equal to (i.e., ≥) 0.2 mol %, ≥0.5 mol %, ≥1 mol %, ≥1.5 mol %, ≥2 mol %, ≥2.5 mol %, ≥3 mol %, ≥3.5 mol %, ≥4 mol %, ≥4.5 mol %, ≥5 mol %, ≥5.5 mol %, ≥6 mol %, ≥6.5 mol %, ≥7 mol %, ≥7.5 mol %, ≥8 mol %, ≥8.5 mol %, ≥9 mol %, ≥9.5 mol %, ≥10 mol %, ≥10.5 mol %, or greater. In some embodiments, the TiO₂ concentration in the outer common cladding region 116 may be less than or equal to (i.e., ≤) 11 mol %, ≤10.5 mol %, ≤10 mol %, ≤9.5 mol %, ≤9 mol %, ≤8.5 mol %, ≤8 mol %, ≤7.5 mol %, ≤7 mol %, ≤6.5 mol %, ≤6 mol %, ≤5.5 mol %, 5 mol %, ≤4.5 mol %, ≤4 mol %, ≤3.5 mol %, ≤3 mol %, ≤2.5 mol %, ≤2 mol %, ≤1.5 mol %, ≤1 mol %, ≤0.5 mol %, or less.

As additional non-limiting examples, in some embodiments, such as the eight-core multicore optical fiber 100 shown in FIGS. 1B and 1D, the TiO₂ concentration in the outer common cladding region 116 may be greater than or equal to (i.e., ≥) 2.2 mol % and less than or equal to (i.e., ≤) 11 mol %—including all sub-ranges or values therebetween. For example, the TiO₂ concentration in the outer common cladding region 116 may be ≥2.2 mol % and ≤11 mol %, ≥2.2 mol % and ≤9 mol %, ≥2.2 mol % and ≤7 mol %, ≥2.2 mol % and ≤5 mol %, ≥2.2 mol % and ≤3 mol %, ≥3 mol % and ≤11 mol %, ≥3 mol % and ≤9 mol %, ≥3 mol % and ≤7 mol %, ≥3 mol % and ≤5 mol %, ≥5 mol % and ≤11 mol %, ≥5 mol % and ≤9 mol %, ≥5 mol % and ≤7 mol %, ≥7 mol % and ≤11 mol %, ≥7 mol % and ≤9 mol %, or ≥9 mol % and ≤11 mol %. In some embodiments, the TiO₂ concentration in the outer common cladding region 116 may be greater than or equal to (i.e., ≥) 2.2 mol %, ≥2.5 mol %, ≥3 mol %, ≥3.5 mol %, ≥4 mol %, ≥4.5 mol %, ≥5 mol %, ≥5.5 mol %, ≥6 mol %, ≥6.5 mol %, ≥7 mol %, ≥7.5 mol %, ≥8 mol %, ≥8.5 mol %, ≥9 mol %, ≥9.5 mol %, ≥10 mol %, ≥10.5 mol %, or greater. In some embodiments, the TiO₂ concentration in the outer common cladding region 116 may be less than or equal to (i.e., ≤) 11 mol %, ≤10.5 mol %, ≤10 mol %, ≤9.5 mol %, ≤9 mol %, ≤8.5 mol %, ≤8 mol %, ≤7.5 mol %, ≤7 mol %, ≤6.5 mol %, ≤6 mol %, ≤5.5 mol %, 5 mol %, ≤4.5 mol %, ≤4 mol %, ≤3.5 mol %, ≤3 mol %, ≤2.5 mol %, or less.

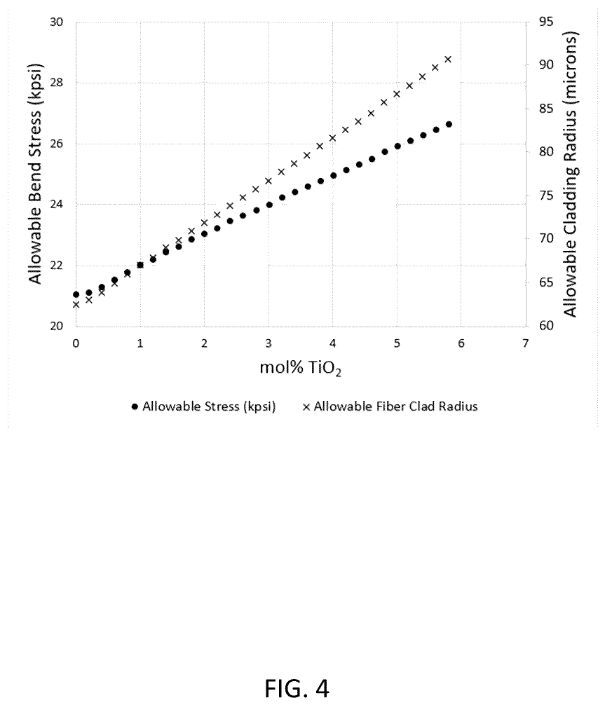

FIG. 4 is a plot of the modeled values of the allowable bend stress and allowable common cladding radius R_{CC} (or the radius of the glass fiber 105) as a function of the TiO₂ dopant level in mol %. As a non-limiting example, a dopant concentration of 4.6% mol % may enable a common radius to be as high as 85 μm. A greater common cladding radius R_{CC} may be implemented while still achieving superior mechanical reliability by further increasing the TiO₂ concentration. However, in some embodiments, the TiO₂ concentration may not be greater than 11 mol % so that crystallization may be limited as crystallization may also function as a defect.

### Exemplary Multicore Optical Fibers

Table 3 summarizes the designs for exemplary multicore optical fibers having six core elements. The outer diameter of the glass fiber or the common cladding (2×R₆) ranges between 126 μm and 146 μm. Table 4 summarizes the designs for additional exemplary multicore optical fiber having eight core elements. The outer diameter of the glass fiber or the common cladding (2×R₆) ranges between 145 and 170 microns. As shown, the multicore optical fibers described herein provide low crosstalk and coating leakage losses at 1550 nm, with the greater glass fiber diameters providing combination of even lower crosstalk and coating leakage losses at 1550 nm.

TABLE 3

| 6-core geometry | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Nearest Neighbor | −30 | −35 | −40 | −30 | −35 | −40 | −30 | −35 | −40 |
| Crosstalk, XT_{NN} (dB) | | | | | | | | | |
| Coating Leakage Loss | 0.1 | 0.1 | 0.1 | 0.05 | 0.05 | 0.05 | 0.01 | 0.01 | 0.01 |
| (dB/km) | | | | | | | | | |
| Distance between Centers | 36.8 | 38.9 | 41 | 36.8 | 38.9 | 41 | 36.8 | 38.9 | 41 |
| of Nearest Neighbor Core | | | | | | | | | |
| Elements, D_{NN} (μm) | | | | | | | | | |
| Core to Coating Distance, | 26.4 | 26.4 | 26.4 | 27.8 | 27.8 | 27.8 | 30.9 | 30.9 | 30.9 |
| d_{CC} (microns) | | | | | | | | | |
| Second Nearest Neighbor | −63.5 | −74.2 | −84.9 | −63.5 | −74.2 | −84.9 | −63.5 | −74.2 | −84.9 |
| Crosstalk, XT_{2NN} (dB) | | | | | | | | | |
| Relative Refractive Index | 0 | 0 | 0 | 0 | 0 | 0 | 0 | 0 | 0 |
| of Inner Common | | | | | | | | | |
| Cladding Region, D₄ | | | | | | | | | |
| (% D) | | | | | | | | | |
| Thickness of Depressed | 4 | 4 | 4 | 4 | 4 | 4 | 4 | 4 | 4 |
| Index Common Cladding | | | | | | | | | |
| Region, t_{DI} (μm) | | | | | | | | | |
| Minimum Relative | −0.4 | −0.25 | −0.45 | −0.3 | −0.5 | −0.25 | −0.45 | −0.35 | −0.4 |
| Refractive Index of | | | | | | | | | |
| Depressed Index | | | | | | | | | |
| Common Cladding | | | | | | | | | |
| Region, D_{5 min} (%) | | | | | | | | | |
| Thickness of TiO₂-doped | 4 | 4 | 4 | 4 | 4 | 4 | 4 | 4 | 4 |
| Outer Common Cladding | | | | | | | | | |
| Region, t_{OC} (μm) | | | | | | | | | |
| TiO₂-concentration of | 0.3 | 0.7 | 1.1 | 0.6 | 1.0 | 1.4 | 1.2 | 1.6 | 2.0 |
| Outer Common Cladding | | | | | | | | | |
| Region (mol %) | | | | | | | | | |
| Radius to Centers of Core | 36.8 | 38.9 | 41 | 36.8 | 38.9 | 41 | 36.8 | 38.9 | 41 |
| Elements, R_{CE} = D_{NN} | | | | | | | | | |
| (μm) | | | | | | | | | |
| Outer Radius of Inner | 55.2 | 57.3 | 59.4 | 56.6 | 58.7 | 60.8 | 59.7 | 61.8 | 63.9 |
| Common Cladding | | | | | | | | | |
| Region, R₄ = R₅ − t_{DI} (μm) | | | | | | | | | |
| Outer Radius of | 59.2 | 61.3 | 63.4 | 60.6 | 62.7 | 64.8 | 63.7 | 65.8 | 67.9 |
| Depressed Index | | | | | | | | | |
| Common Cladding | | | | | | | | | |
| Region, R₅ = R₆ − t_{OC} (μm) | | | | | | | | | |
| Outer Radius of TiO₂- | 63.2 | 65.3 | 67.4 | 64.6 | 66.7 | 68.8 | 67.7 | 69.8 | 71.9 |
| doped Outer Common | | | | | | | | | |
| Cladding Region, R₆ = | | | | | | | | | |
| d_{CC} + R_{CE} (μm) | | | | | | | | | |

TABLE 4

| | Ex. | Ex. | Ex. | Ex. | Ex. | Ex. | Ex. | Ex. | Ex. |
|---|---|---|---|---|---|---|---|---|---|
| 8-core geometry | 10 | 11 | 12 | 13 | 14 | 15 | 16 | 17 | 18 |
| Nearest Neighbor | −30 | −35 | −40 | −30 | −35 | −40 | −30 | −35 | −40 |
| Crosstalk, XT_{NN} (dB) | | | | | | | | | |
| Coating Leakage Loss | 0.1 | 0.1 | 0.1 | 0.05 | 0.05 | 0.05 | 0.01 | 0.01 | 0.01 |
| (dB/km) | | | | | | | | | |
| Distance between | 36.8 | 38.9 | 41 | 36.8 | 38.9 | 41 | 36.8 | 38.9 | 41 |
| Centers of Nearest | | | | | | | | | |
| Neighbor Core Elements, | | | | | | | | | |
| D_{NN} (μm) | | | | | | | | | |
| Core to Coating | 26.4 | 26.4 | 26.4 | 27.8 | 27.8 | 27.8 | 30.9 | 30.9 | 30.9 |
| Distance, d_{CC} (microns) | | | | | | | | | |
| Second Nearest Neighbor | −63.5 | −74.2 | −84.9 | −63.5 | −74.2 | −84.9 | −63.5 | −74.2 | −84.9 |
| Crosstalk, XT_{2NN} (dB) | | | | | | | | | |
| Relative Refractive Index | 0 | 0 | 0 | 0 | 0 | 0 | 0 | 0 | 0 |
| of Inner Common | | | | | | | | | |
| Cladding Region, D₄ | | | | | | | | | |
| (% D) | | | | | | | | | |
| Thickness of Depressed | 4 | 4 | 4 | 4 | 4 | 4 | 4 | 4 | 4 |
| Index Common Cladding | | | | | | | | | |
| Region, t_{DI} (μm) | | | | | | | | | |
| Minimum Relative | −0.4 | −0.25 | −0.45 | −0.3 | −0.5 | −0.25 | −0.45 | −0.35 | −0.4 |
| Refractive Index of | | | | | | | | | |
| Depressed Index | | | | | | | | | |
| Common Cladding | | | | | | | | | |
| Region, D_{5 min} (%) | | | | | | | | | |
| Thickness of TiO₂-doped | 4 | 4 | 4 | 4 | 4 | 4 | 4 | 4 | 4 |
| Outer Common Cladding | | | | | | | | | |
| Region, t_{OC} (μm) | | | | | | | | | |
| TiO₂-concentration of | 2.6 | 3.2 | 3.8 | 3.0 | 3.4 | 4.0 | 3.6 | 4.0 | 4.6 |
| Outer Common Cladding | | | | | | | | | |
| Region (mol %) | | | | | | | | | |
| Radius to Centers of | 48.1 | 50.8 | 53.6 | 48.1 | 50.8 | 53.6 | 48.1 | 50.8 | 53.6 |
| Core Elements, R_{CE} = | | | | | | | | | |
| D_{NN} (μm) | | | | | | | | | |
| Outer Radius of Inner | 66.5 | 69.2 | 72.0 | 67.9 | 70.6 | 73.4 | 71.0 | 73.7 | 76.5 |
| Common Cladding | | | | | | | | | |
| Region, R₄ = R₅ − t_{DI} (μm) | | | | | | | | | |
| Outer Radius of | 70.5 | 73.2 | 76.0 | 71.9 | 74.6 | 77.4 | 75.0 | 77.7 | 80.5 |
| Depressed Index | | | | | | | | | |
| Common Cladding | | | | | | | | | |
| Region, R₅ = R₆ − t_{OC} (μm) | | | | | | | | | |
| Outer Radius of TiO₂- | 74.5 | 77.2 | 80.0 | 75.9 | 78.6 | 81.4 | 79.0 | 81.7 | 84.5 |
| doped Outer Common | | | | | | | | | |
| Cladding Region, R₆ = | | | | | | | | | |
| d_{CC} + R_{CE} (μm) | | | | | | | | | |

### Exemplary Process

The multicore optical fibers of the present disclosure can be made using any suitable method for forming a multicore optical fiber. See, for example, U.S. Pat. No. 11,370,689 B2, the entire content of which is incorporated herein by reference.

An exemplary method that is used to form the multicore optical fiber (or any of the alternative embodiments thereof) described herein includes forming a glass blank for common cladding and drilling multiple holes along the length of the glass blank for core canes to be inserted. In some embodiments, an annular region of the common cladding glass blank may be doped with a down dopant such as fluorine. In some embodiments, the outermost region of the common cladding glass blank may be doped with TiO₂. The down-doped annular region and the TiO₂-doped outermost region each include a composition corresponding to the depressed index common cladding region and the TiO₂-doped outer common cladding region, respectively, of the multicore optical fiber.

A core cane may be prepared by forming a core region of the core cane, followed by deposition of one or more clad layers on the core region. One or more of the core region(s) and/or the clad layer(s) may be doped with up-dopant(s) and/or down-dopant(s). The core region and the clad layer(s) each have a composition corresponding to the core region and dedicated cladding region(s), respectively, of the core element of the multicore optical fiber.

Techniques for forming the core canes, the common cladding glass blank, including the doped annular regions, include, without limitation, outside vapor deposition (OVD), vapor axial deposition (VAD), plasma-enhanced chemical vapor deposition (PCVD), modified chemical vapor deposition (MCVD), or any other known method.

To prepare the fiber preform, the core canes may be inserted into the holes drilled in the common cladding glass blank. The fiber preform may then be assembled by thermally closing the gap between the inserted cane and the drilled hole. The assembled preform may then be drawn into a multicore optical fiber. The multicore optical fiber may then be coated with one or more coatings, such as a primary coating, a secondary coating, etc. Example coating materials and methods are discussed in U.S. Pat. No. 9,057,817, the entire content of which is incorporated by reference herein.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multicore optical fiber, comprising:
a common cladding having a radius R_{CC} that is greater than or equal to 126 μm and less than or equal to 180 μm, the common cladding comprising:
an inner common cladding region; and
an outer common cladding region surrounding the inner common cladding region, wherein the outer common cladding region comprises a TiO₂-doped glass region; and
a plurality of core elements disposed within the common cladding, at least one core element of the plurality of core elements comprising:
a core region;
a dedicated inner cladding region surrounding the core region; and
a dedicated outer cladding region surrounding the dedicated inner cladding region;
wherein a mode field diameter at 1310 nm of the at least one core element is greater than or equal to 8.6 μm;
wherein the at least one core element is separated from a nearest-neighbor core element by a minimum separation distance D_{NN} that is greater than or equal to 35 μm and less than or equal to 43 μm.

2. The multicore optical fiber of claim 1, wherein a crosstalk XT_{NN} between nearest-neighbor core elements of the plurality of core elements at 1550 nm is less than or equal to −30 dB, less than or equal to −35 dB, or less than or equal to −40 dB, for a 100 km length of the multicore optical fiber, wherein the crosstalk XT_{NN} is determined based on XT_{NN}(dB)=−2.38 D_{NN}+57.6.

3. The multicore optical fiber of claim 1, wherein a coating leakage loss LL_{C} at 1550 nm from the at least one core element of the plurality of core elements is less than about 0.1 dB/km, less than about 0.05 dB/km, or less than about 0.01 dB/km, wherein the coating leakage loss LL_{C} is determined based on LL_{C}(dB/km)=10^{-0.27dcc}+5, wherein d_{CC} is a radial distance between a centerline of the at least one core element of the plurality of core elements and the outer radius R_{CC} of the common cladding.

4. The multicore optical fiber of claim 1, wherein the mode field diameter at 1310 nm of the at least one core element is less than or equal to 9.5 μm.

5. The multicore optical fiber of claim 1, wherein a mode field diameter at 1550 nm of the at least one core element is greater than or equal to 9.5 μm and less than or equal to 10.5 μm.

6. The multicore optical fiber of claim 1, wherein the common cladding further comprises a depressed index common cladding region disposed between the inner common cladding region and the outer common cladding region.

7. The multicore optical fiber of claim 6, wherein the depressed index common cladding region includes a thickness that is greater than or equal to 2 μm and less than or equal to 6 μm.

8. The multicore optical fiber of claim 6, wherein the depressed index common cladding region includes a minimum relative refractive index D₅ₘᵢₘ that is greater than or equal to −0.5% and less than or equal to −0.2%.

9. The multicore optical fiber of claim 1, wherein the outer common cladding region includes a thickness that is greater than or equal to 1 μm and less than or equal to 6 μm.

10. The multicore optical fiber of claim 1, wherein the TiO₂ concentration in the outer common cladding region is greater than or equal to 0.2 mol % and less than or equal to 11 mol %.

11. The multicore optical fiber of claim 1, wherein the core region of the at least one core element includes a step-index profile and a maximum relative refractive index Δ₁ₘₐₓ greater than or equal to 0.33% and less than or equal to 0.40%.

12. The multicore optical fiber of claim 1, wherein the dedicated outer cladding region of the at least one core element includes a minimum relative refractive index Δ₃ₘᵢₙ greater than or equal to −0.7% and less than or equal to −0.3% and a volume V₃ greater than or equal to −70% Δ-micron² and less than or equal to −30% Δ-micron².

13. The multicore optical fiber of claim 1, wherein the core region of the at least one core element includes a radius greater than or equal to 4 μm and less than or equal to 5 μm, wherein the dedicated inner cladding region of the at least one core element includes a thickness greater than or equal to 4 μm and less than or equal to 5.5 μm, wherein the dedicated outer cladding region of the at least one core element includes a thickness greater than or equal to 2 μm and less than or equal to 6 μm.

14. The multicore optical fiber of claim 1, wherein a diameter of the at least one core element is greater than or equal to 22 μm and less than or equal to 28 μm.

15. The multicore optical fiber of claim 1, wherein the plurality of core elements comprises at least six core elements.

16. The multicore optical fiber of claim 1, wherein the plurality of core elements is disposed within an annular region of the inner common cladding region, and wherein a centerline of each core element of the plurality of the core elements is centered on a circle having a radius R_{CE} from a central fiber axis CL of the multicore optical fiber, and wherein the plurality of core elements is spaced equally apart along a circumference of the circle having the radius R_{CE}.

17. The multicore optical fiber of claim 16, wherein the radius R_{CE} is greater than or equal to 35 μm and less than or equal to 57 μm.

18. The multicore optical fiber of claim 1, wherein a radial distance d_{CC} between a centerline of the at least one core element of the plurality of core elements and the outer radius R_{CC} of the common cladding is greater than or equal to 22 μm and less than or equal to 35 μm.

19. The multicore optical fiber of claim 1, wherein the plurality of core elements comprises all core elements that are disposed within the common cladding.

20. The multicore optical fiber of claim 1, wherein at least one of a 22 m cable cutoff wavelength or a 2 m fiber cutoff wavelength of the multicore optical fiber is less than or equal to 1260 nm.
